(19) United States
(12) Patent Application Publication
(10) Pub. No.: US 2026/0251671 A1
(43) Pub. Date: Aug. 27, 2026

(54) LOADING APPARATUS AND AUTOMATIC ANALYSIS SYSTEM

(71) Applicant: CANON MEDICAL SYSTEMS CORPORATION, Tochigi (JP)

(72) Inventors: Yao CUI, Dalian (CN); Fei TIAN, Dalian (CN); Takahiro OMORI, Otawara (JP); Tetsushi YAMAMOTO, Otawara (JP)

(73) Assignee: CANON MEDICAL SYSTEMS CORPORATION, Tochigi (JP)

(21) Appl. No.: 19/549,554

(22) Filed: Feb. 25, 2026

(30) Foreign Application Priority Data
Feb. 25, 2025 (CN) 202510209373.8

(51) Int. Cl. G01N 35/00; G01N 35/02; G01N 35/04

(52) U.S. Cl. CPC G01N 35/0099; G01N 35/00584; G01N 35/02; G01N 2035/0439

(57) ABSTRACT

A loading apparatus according to the present embodiment is a loading apparatus for taking out and taking in a reagent container from and to a rotatable reagent storage of an automatic analysis apparatus, and includes a holding part and an extendable and retractable unit. The holding part is a member for holding the reagent container. The extendable and retractable unit includes two- or more-stage arms that are extendable and retractable in a direction of a rotational center of the reagent storage, and is provided with the holding part at one end of the two- or more-stage arms. The extendable and retractable unit extends in the direction of the rotational center of the reagent storage to take out and take in the reagent container from and to the reagent storage using the holding part.

### CROSS-REFERENCE TO RELATED APPLICATIONS

This application is based upon and claims the benefit of priority from Chinese Patent Application No. 202510209373.8, filed on Feb. 25, 2025, the entire contents of all of which are incorporated herein by reference.

### FIELD

Embodiments described herein relate generally to a loading apparatus and an automatic analysis system.

### BACKGROUND

In an automatic analysis apparatus that performs in vitro diagnosis, reagents are placed in reagent containers and stored in a reagent storage, and the low-temperature and sealed environment of the reagent storage is used to avoid evaporation and deterioration of the reagents and to ensure the accuracy of diagnostic results. Depending on the size of the apparatus and test items in which a medical institution is engaged, the reagent storage may store dozens or even hundreds of kinds of reagents at the same time. The reagent containers in which the reagents are stored are taken out and taken in in accordance with a user's request for use. As automation becomes more widespread, taking out and taking in the reagent containers from and to the reagent storage will be performed by automated loading apparatuses instead of manual operations by physicians.

Conventionally, it has been general that the loading apparatus is loaded as a whole, or at least part thereof, above the reagent storage, and the reagent containers are taken out and taken in via a reagent storage opening at the top of the reagent storage.

However, the loading apparatus with such a structure requires the use of space above the reagent storage, which has a harmful effect on the layout of the entire system (Drawback 1).

In addition, since the loading apparatus with such a structure has a short stroke moving in the horizontal direction, it can generally accommodate only a reagent storage loaded with only one round of reagent containers. For a reagent storage loaded with a plurality of rounds of reagent containers, it is conceivable to lengthen the horizontal moving stroke of the loading apparatus to move the loading apparatus within a wider range, but this leads to a larger occupied space for the entire system (Drawback 2).

### BRIEF DESCRIPTION OF THE DRAWINGS

FIG. 1A is an illustrative diagram of the configuration of a loading apparatus according to a first embodiment, the diagram illustrating a retracted state;

FIG. 1B is a diagram of an extended state of FIG. 1A;

FIG. 2A is an illustrative diagram of the configuration of an apparatus body in the loading apparatus according to the first embodiment;

FIG. 2B is a diagram of the same from a different direction from that of FIG. 2A;

FIG. 3A is an illustrative diagram of the configuration of an extendable and retractable unit in the loading apparatus according to the first embodiment, the diagram illustrating a retracted state;

FIG. 3B is a diagram of an extended state of FIG. 3A;

FIG. 4 is an illustrative diagram of the configuration of a first connecting member of the extendable and retractable unit in the loading apparatus according to the first embodiment;

FIG. 5 is an illustrative diagram of an example of the configuration of a reagent storage loaded with a plurality of rounds of reagent containers, which can be accommodated by the loading apparatus according to the first embodiment;

FIG. 6A is an illustrative diagram of the operation of the loading apparatus during a process of taking in a reagent container to a reagent storage by the loading apparatus according to the first embodiment;

FIG. 6B is an illustrative diagram of the operation of the loading apparatus in FIG. 6A;

FIG. 6C is an illustrative diagram of the operation of the loading apparatus in FIG. 6A;

FIG. 6D is an illustrative diagram of the operation of the loading apparatus in FIG. 6A;

FIG. 6E is an illustrative diagram of the operation of the loading apparatus in FIG. 6A;

FIG. 7 is an illustrative diagram of the configuration of a loading apparatus according to a first modification of the first embodiment;

FIG. 8A is an illustrative diagram of the configuration of a support unit in the loading apparatus according to the first modification of the first embodiment, the diagram illustrating a non-supporting state;

FIG. 8B is a diagram of a supporting state of FIG. 8A;

FIG. 9A is an illustrative diagram of the operation of the loading apparatus during a process of taking in the reagent container to the reagent storage by the loading apparatus according to the first modification of the first embodiment;

FIG. 9B is an illustrative diagram of the operation of the loading apparatus in FIG. 9A;

FIG. 9C is an illustrative diagram of the operation of the loading apparatus in FIG. 9A;

FIG. 9D is an illustrative diagram of the operation of the loading apparatus in FIG. 9A;

FIG. 9E is an illustrative diagram of the operation of the loading apparatus in FIG. 9A;

FIG. 10A is an illustrative diagram of the operation of the loading apparatus during a process of taking out the reagent container from the reagent storage by the loading apparatus according to the first modification of the first embodiment;

FIG. 10B is an illustrative diagram of the operation of the loading apparatus in FIG. 10A;

FIG. 10C is an illustrative diagram of the operation of the loading apparatus in FIG. 10A;

FIG. 10D is an illustrative diagram of the operation of the loading apparatus in FIG. 10A;

FIG. 10E is an illustrative diagram of the operation of the loading apparatus in FIG. 10A;

FIG. 11 is an illustrative diagram of the configuration of a loading apparatus according to a second modification of the first embodiment;

FIG. 12A is an illustrative diagram of a supporting situation of an extendable and retractable arm by the support unit during a process in which the extendable and retractable unit extends in the loading apparatus according to the second modification of the first embodiment;

FIG. 12B is an illustrative diagram of the supporting situation of the extendable and retractable arm by the support unit in FIG. 12A;

FIG. 12C is an illustrative diagram of the supporting situation of the extendable and retractable arm by the support unit in FIG. 12A;

FIG. 13 is a flowchart diagram illustrating the operation of an automatic analysis system according to a second embodiment with a case of a reagent storage loaded with two rounds of reagent containers as an example;

FIG. 14A is an illustrative diagram of the operation of taking in the reagent container to an outer circumference of the reagent storage loaded with two rounds of reagent containers in the automatic analysis system according to the second embodiment;

FIG. 14B is an illustrative diagram of the operation of FIG. 14A;

FIG. 15A is an illustrative diagram of the operation of taking in the reagent container to an inner circumference of the reagent storage loaded with two rounds of reagent containers in the automatic analysis system according to the second embodiment; and

FIG. 15B is an illustrative diagram of the operation of FIG. 15A.

### DETAILED DESCRIPTION

The loading apparatus according to the present embodiment is a loading apparatus for taking out and taking in a reagent container from and to a rotatable reagent storage of an automatic analysis apparatus, and includes a holding part and an extendable and retractable unit. The holding part is a member for holding the reagent container. The extendable and retractable unit includes two- or more-stage arms that are extendable and retractable in a direction of a rotational center of the reagent storage, and is provided with the holding part at one end of the two- or more-stage arms. In the loading apparatus according to the present embodiment, the extendable and retractable unit extends in the direction of the rotational center of the reagent storage to take out and take in the reagent container from and to the reagent storage using the holding part.

Embodiments will be described below with reference to the accompanying drawings. Each embodiment described below is mentioned for the purpose of understanding the present disclosure, but the disclosure is not limiting.

In the following description, similar components will be denoted by the same symbol, and the description of such components will be simplified or omitted as the case may be.

### First Embodiment

The first embodiment is a loading apparatus for taking out and taking in a reagent container from and to a rotatable reagent storage of an automatic analysis apparatus.

### Configuration

First, the configuration of the loading apparatus according to the first embodiment will be described.

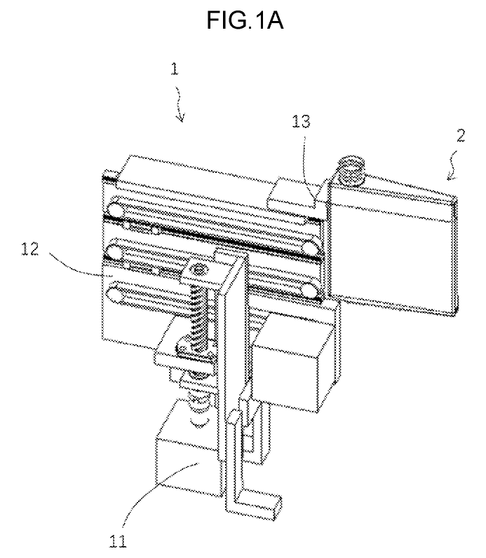

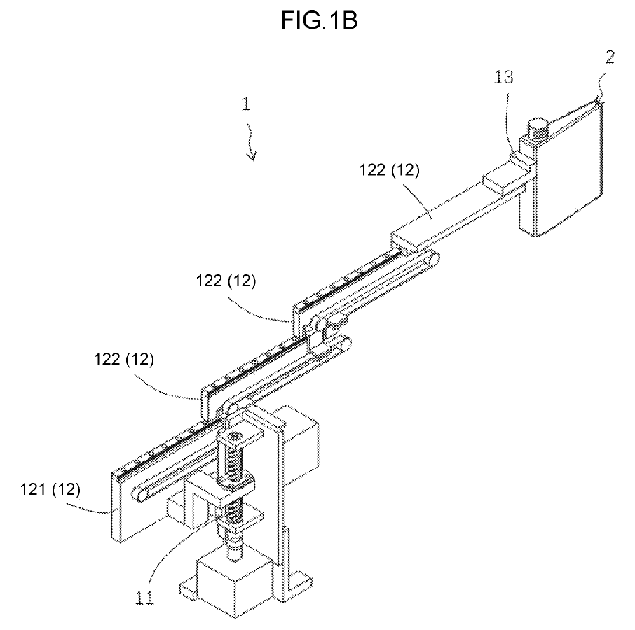

FIGS. 1A and 1B are illustrative diagrams of the configuration of the loading apparatus according to the first embodiment, with FIG. 1A illustrating a retracted state and FIG. 1B illustrating an extended state. FIGS. 1A and 1B illustrate the loading apparatus 1 grabbing a reagent container 2, but the reagent container 2 itself is not included in the loading apparatus 1, and this is also true for the other figures.

As illustrated in FIGS. 1A and 1B, the loading apparatus 1 according to the present embodiment includes an apparatus body 11, an extendable and retractable unit 12, a pick-up part 13 (an example of a "holding part"), and a control unit not illustrated.

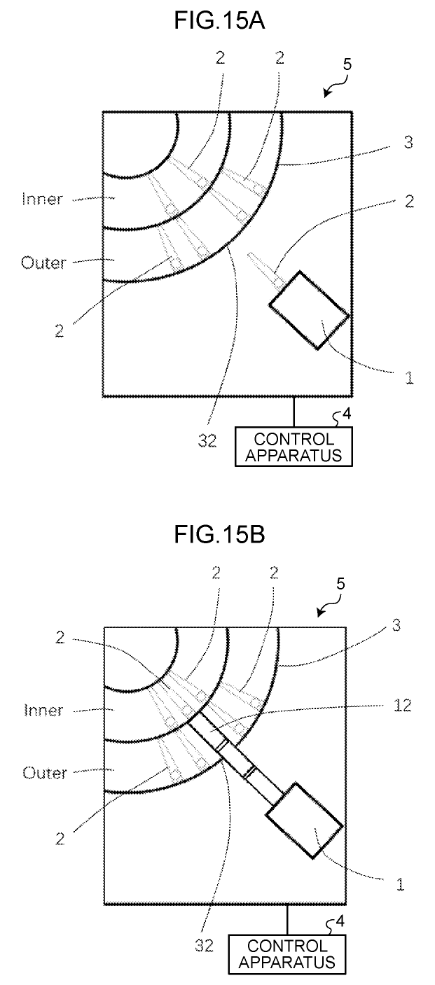

The apparatus body 11 is provided near a reagent storage 3, and provided on the side of the reagent storage 3 in the horizontal direction, for example (for the reagent storage 3, refer to FIGS. 15A and 15B, for example). The extendable and retractable unit 12 is mounted on the apparatus body 11. The apparatus body 11 also has a function of raising and lowering the extendable and retractable unit 12 in the up and down direction (that is, a height direction crossing an extension and retraction direction of the extendable and retractable unit 12).

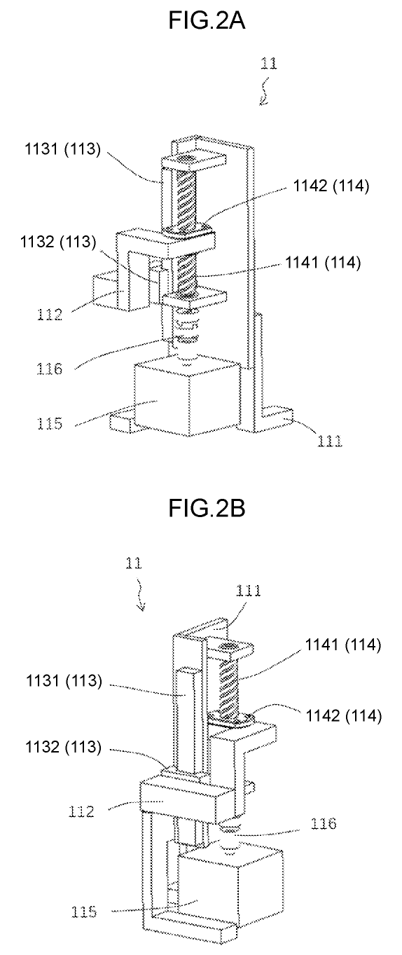

FIGS. 2A and 2B are illustrative diagrams the configuration of the apparatus body 11.

As illustrated in FIGS. 2A and 2B, the apparatus body 11 has a body bracket 111 and a mounting bracket 112.

The body bracket 111 is used to fix the entire loading apparatus 1 to a certain position, and the entire loading apparatus 1 can be fixed to another apparatus or the ground, for example.

The mounting bracket 112 is mounted on the body bracket 111 via a slide guide mechanism 113 slidably in the up and down direction. Specifically, as illustrated in FIG. 2B, the slide guide mechanism 113 has a guide rail 1131 formed on the body bracket 111 and extending in the up and down direction, and a slider 1132 formed on the mounting bracket 112 and engaging with the guide rail 1131. In the slide guide mechanism 113, as the slider 1132 slides on the guide rail 1131, the mounting bracket 112 slides in the up and down direction with respect to the body bracket 111.

To provide driving force to the sliding of the mounting bracket 112 with respect to the body bracket 111, the apparatus body 11 has a power transmission mechanism 114, a motor 115, and a coupling 116 as illustrated in FIGS. 2A and 2B. The power transmission mechanism 114 has a screw 1141 mounted on the body bracket 111 along the up and down direction and a nut 1142 mounted on the mounting bracket 112 and engaging with the screw 1141. The motor 115 is mounted on the body bracket 111 and is connected to the screw 1141 of the power transmission mechanism 114 via the coupling 116.

When the motor 115 rotates, the driving force from the motor 115 is transmitted via the coupling 116 to the screw 1141 of the power transmission mechanism 114 to rotate the screw 1141. Along with this, the nut 1142 slides on the screw 1141 in the up and down direction, and causes the mounting bracket 112 to slide in the up and down direction with respect to the body bracket 111 along therewith. Thus, the mounting bracket 112 can be raised and lowered in the up and down direction.

When the motor 115 stops rotating, the mounting bracket 112 stops being raised and lowered and stays at a position at that time. Thus, it is possible to maintain the position of the mounting bracket 112 in the up and down direction.

The extendable and retractable unit 12 is mounted on the mounting bracket 112. Thus, by the above-described configuration in which the mounting bracket 112 is mounted on the body bracket 111 slidably in the up and down direction, the extendable and retractable unit 12 is provided relatively movably with respect to the apparatus body 11 in the up and down direction. This can raise and lower the extendable and retractable unit 12 with a certain stroke in the up and down direction as needed.

The extendable and retractable unit 12 is used to move the pick-up part 13 mounted on the extendable and retractable unit 12 to a certain position in the horizontal direction. To accommodate a reagent storage loaded with a plurality of rounds of reagent containers, the extendable and retractable unit 12 is configured as an extendable and retractable structure. At the same time, to meet the requirement for downsizing of the entire apparatus, the extendable and retractable structure of the extendable and retractable unit 12 is configured as a multi-stage extendable and retractable structure.

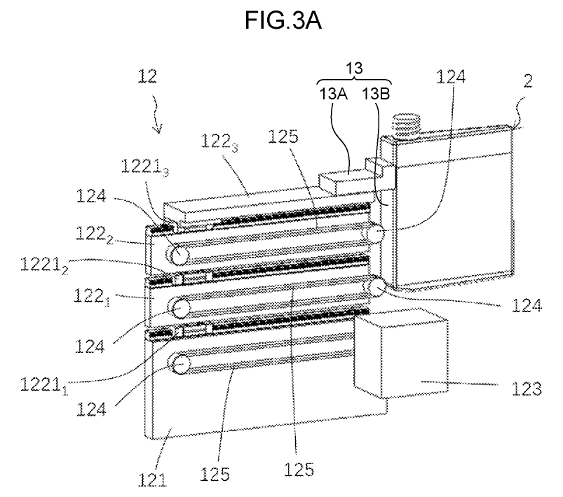

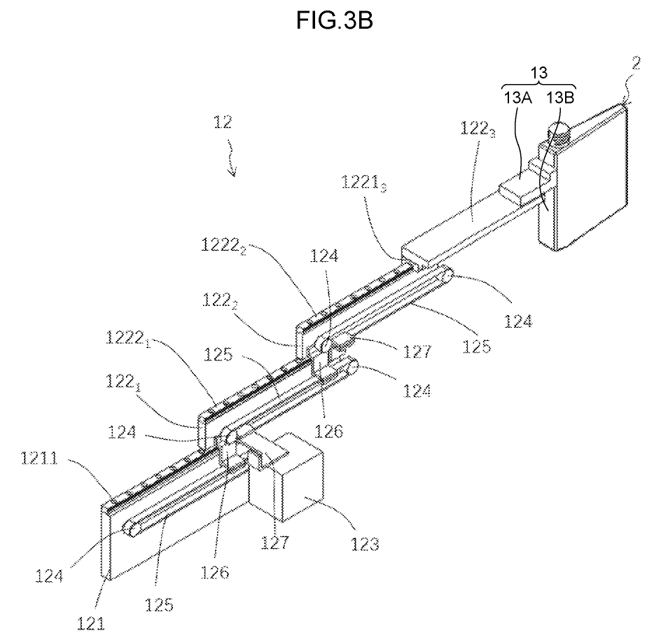

FIG. 3A and FIG. 3B are illustrative diagrams of the configuration of the extendable and retractable unit 12 in the loading apparatus according to the present embodiment. Here, FIG. 3A is an illustrative diagram of a state in which the extendable and retractable unit 12 is fully retracted, and FIG. 3B is an illustrative diagram of a state in which the extendable and retractable unit 12 is fully extended.

As illustrated in FIG. 3A and FIG. 3B, the extendable and retractable unit 12 has a fixed arm 121, N-stage (N ≥ 2) extendable and retractable arms 122 (an example of "arms"), and a motor 123 (a drive part). The extendable and retractable arms 122 will be described below with N = 3, that is, a three-stage extendable and retractable extendable and retractable unit 12 as an example. In FIG. 3A and FIG. 3B, to distinguish the three-stage extendable and retractable arms 122, a subscript representing the stage of the extendable and retractable arm is added to the end of the sign "122" representing the extendable and retractable arm: "122₁" represents a first-stage extendable and retractable arm, "122₂" represents a second-stage extendable and retractable arm, and "122₃" represents a third-stage extendable and retractable arm.

The fixed arm 121 is a plate-shaped member extending long in the horizontal direction.

The fixed arm 121 is mounted on the apparatus body 11. Specifically, as described above, the fixed arm 121 is mounted on the mounting bracket 112 of the apparatus body 11, and can be raised and lowered in the up and down direction with respect to the body bracket 111 of the apparatus body 11 along with the mounting bracket 112, so that the entire extendable and retractable unit 12 can be raised and lowered in the up and down direction with respect to the apparatus body 11.

The fixed arm 121 has a guide rail 1211 along its extension direction that engages with the extendable and retractable arm 122₁described below. The guide rail 1211 is formed, for example, on the top of the fixed arm 121.

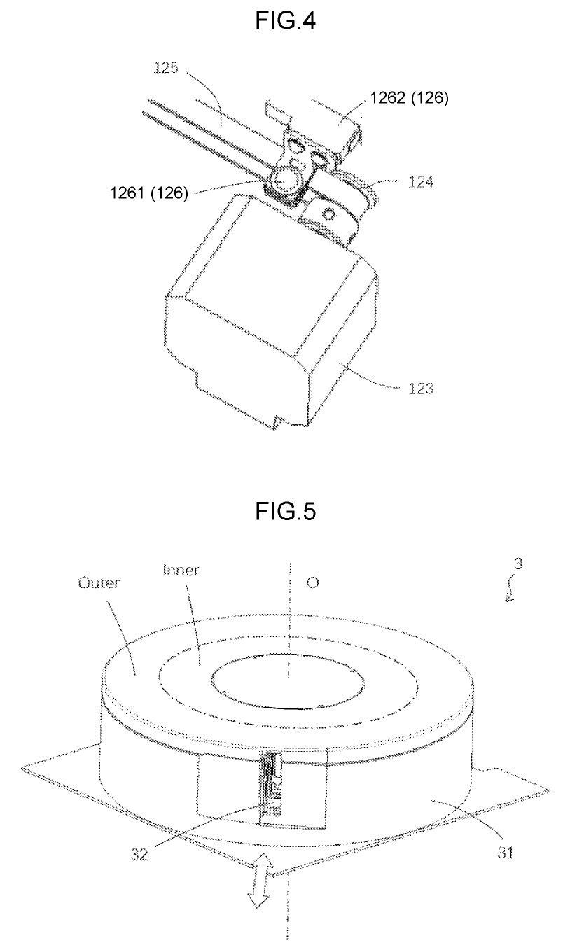

On one side of the fixed arm 121, one pulley 124 is rotatably mounted at one end in the horizontal direction. On the one side of the fixed arm 121, a motor 123 is mounted at the other end in the horizontal direction. As illustrated in FIG. 4, another pulley 124 is fixed to an output shaft of the motor 123. A power transmission belt 125 is wound across the one pulley 124 and the other pulley 124. Thus, when rotating, the motor 123 can rotate the power transmission belt 125 along therewith via the other pulley 124.

Each extendable and retractable arm 122 is a plate-shaped member extending long in the horizontal direction. In FIG. 3A, a first connecting member 126 and a second connecting member 127 described below are omitted in order to illustrate the engagement between the slider and the guide rail between the fixed arm 121 and each extendable and retractable arm 122.

Out of the extendable and retractable arms 122, the first-stage extendable and retractable arm 122₁is mounted on the fixed arm 121 slidably in the horizontal direction. Specifically, the first-stage extendable and retractable arm 122₁has a slider 1221₁that engages with the guide rail 1211 of the fixed arm 121. The slider 1221₁is formed, for example, at the bottom of the first-stage extendable and retractable arm 122₁. By the sliding engagement between the slider 1221₁and the guide rail 1211, the first-stage extendable and retractable arm 122₁is mounted on the fixed arm 121 slidably in the horizontal direction.

As illustrated in FIG. 3B, the first connecting member 126 is provided between the first-stage extendable and retractable arm 122₁and the fixed arm 121. The first connecting member 126 transmits the movement of the power transmission belt 125 of the fixed arm 121 to the first-stage extendable and retractable arm 122₁to extend and retract the extendable and retractable arm 122₁in the horizontal direction with respect to the fixed arm 121.

FIG. 4 illustrates the configuration of the first connecting member 126. As illustrated in FIG. 4, one end 1261 of the first connecting member 126 is fixed to the top of the power transmission belt 125 of the fixed arm 121. Another end 1262 of the first connecting member 126 is fixed to the first-stage extendable and retractable arm 122₁.

Thus, when the motor 123 rotationally drives the power transmission belt 125, the power transmission belt 125 moves the first connecting member 126 along therewith in the horizontal direction. As a result, the first-stage extendable and retractable arm 122₁, to which the first connecting member 126 is fixed, extends and retracts in the horizontal direction with respect to the fixed arm 121.

On one side of the first-stage extendable and retractable arm 122₁, one pulley 124 is rotatably mounted at one end in the horizontal direction, and another pulley 124 is rotatably mounted at the other end in the horizontal direction. A power transmission belt 125 is wound across both these pulleys 124.

The second connecting member 127 that fixes the bottom of the power transmission belt 125 to a case of the motor 123 is provided between the power transmission belt 125 of the first-stage extendable and retractable arm 122₁and the motor 123. The second connecting member 127 may be fixed to the fixed arm 121 instead of the motor 123.

Thus, when the first-stage extendable and retractable arm 122₁extends and retracts in the horizontal direction with respect to the fixed arm 121, the power transmission belt 125 of the first-stage extendable and retractable arm 122₁rotates with respect to the extendable and retractable arm 122₁along with the extension and retraction of the extendable and retractable arm 122₁by the second connecting member 127.

The first-stage extendable and retractable arm 122₁has a guide rail 1222₁extending along its extension direction to engage with the next-stage extendable and retractable arm 122₂. The guide rail 1222₁of the first-stage extendable and retractable arm 122₁may be formed, for example, at the top of the first-stage extendable and retractable arm 122₁.

Out of the extendable and retractable arms 122, the second-stage extendable and retractable arm 122₂is mounted on the first-stage extendable and retractable arm 122₁in a relatively slidable manner in the horizontal direction. Specifically, the second-stage extendable and retractable arm 122₂has a slider 1221₂that engages with the guide rail 1222₁of the first-stage extendable and retractable arm 122₁. The slider 1221₂of the second-stage extendable and retractable arm 122₂is formed, for example, at the bottom of the second-stage extendable and retractable arm 122₂. By the sliding engagement between the slider 1221₂of the second-stage extendable and the guide rail 1222₁of the first-stage extendable and retractable arm 122₁, the second-stage extendable and retractable arm 122₂is mounted on the first-stage extendable and retractable arm 122₁slidably in the horizontal direction.

A first connecting member 126 is provided between the second-stage extendable and retractable arm 122₂and the first-stage extendable and retractable arm 122₁, as well as between the first-stage extendable and retractable arm 122₁and the fixed arm 121. The first connecting member 126 transmits the movement of the power transmission belt 125 of the first-stage extendable and retractable arm 122₁to the second-stage extendable and retractable arm 122₂to extend and retract the second-stage extendable and retractable arm 122₂in the horizontal direction with respect to the first-stage extendable and retractable arm 122₁.

Similar to the first connecting member 126, one end of the first connecting member 126 between the second-stage extendable and retractable arm 122₂and the first-stage extendable and retractable arm 122₁is fixed to the top of the power transmission belt 125 of the first-stage extendable and retractable arm 122₁, and the other end thereof is fixed to the second-stage extendable and retractable arm 122₂.

Thus, when the first-stage extendable and retractable arm 122₁extends and retracts in the horizontal direction with respect to the fixed arm 121, when the power transmission belt 125 of the first-stage extendable and retractable arm 122₁rotates with respect to the extendable and retractable arm 122₁, the power transmission belt 125 of the first-stage extendable and retractable arm 122₁moves the first connecting member 126 between the second-stage extendable and retractable arm 122₂and the first-stage extendable and retractable arm 122₁along therewith in the horizontal direction. As a result, the second-stage extendable and retractable arm 122₂, to which the other end of the first connecting member 126 is fixed, extends and retracts in the horizontal direction with respect to the first-stage extendable and retractable arm 122₁.

On one side of the second-stage extendable and retractable arm 122₂, one pulley 124 is rotatably mounted at one end in the horizontal direction, and another pulley 124 is rotatably mounted at the other end in the horizontal direction. A power transmission belt 125 is wound across both these pulleys 124.

A second connecting member 127 that fixes the bottom of the power transmission belt 125 of the second-stage extendable and retractable arm 122₂and the first-stage extendable and retractable arm 122₁to each other is provided between the power transmission belt 125 of the second-stage extendable and retractable arm 122₂and first-stage extendable and retractable arm 122₁.

Thus, when the second-stage extendable and retractable arm 122₂extends and retracts in the horizontal direction with respect to the first-stage extendable and retractable arm 122₁, the power transmission belt 125 of the second-stage extendable and retractable arm 122₂rotates with respect to the extendable and retractable arm 122₂along with the extension and retraction of the extendable and retractable arm 122₂by the second connecting member 127.

The second-stage extendable and retractable arm 122₂has a guide rail 1222₂extending along its extension direction to engage with the next-stage extendable and retractable arm 122₃. The guide rails 1222₂of the second-stage extendable and retractable arm 122₂may be formed, for example, at the top of the second-stage extendable and retractable arm 122₂.

Out of the extendable and retractable arms 122, the third-stage (final-stage) extendable and retractable arm 122₃is mounted on the second-stage extendable and retractable arm 122₂in a relatively slidable manner in the horizontal direction. Specifically, the third-stage extendable and retractable arm 122₃has a slider 1221₃that engages with the guide rail 1222₂of the second-stage extendable and retractable arm 122₂. The slider 1221₃of the third-stage extendable and retractable arm 122₃is formed, for example, at the bottom of the third-stage extendable and retractable arm 122₃. By the sliding engagement between the slider 1221₃of the third-stage extendable and retractable arm 122₃and the guide rail 1222₂of the second-stage extendable and retractable arm 122₂, the third-stage extendable and retractable arm 122₃is mounted on the second-stage extendable and retractable arm 122₂slidably in the horizontal direction.

A first connecting member (not illustrated in FIG. 3B) is provided between the third-stage extendable and retractable arm 122₃and the second-stage extendable and retractable arm 122₂, as well as between the first-stage extendable and retractable arm 122₁and the fixed arm 121. The first connecting member transmits the movement of the power transmission belt 125 of the second-stage extendable and retractable arm 122₂to the third-stage extendable and retractable arm 122₃to extend and retract the third-stage extendable and retractable arm 122₃in the horizontal direction with respect to the second-stage extendable and retractable arm 122₂.

Similar to the first connecting member 126, one end of the first connecting member between the third-stage extendable and retractable arm 122₃and the second-stage extendable and retractable arm 122₂is fixed to the top of the power transmission belt 125 of the second-stage extendable and retractable arm 122₂, and the other end thereof is fixed to the third-stage extendable and retractable arm 122₃.

Thus, when the second-stage extendable and retractable arm 122₂extends and retracts in the horizontal direction with respect to the first-stage extendable and retractable arm 122₁, when the power transmission belt 125 of the second-stage extendable and retractable arm 122₂rotates with respect to the extendable and retractable arm 122₂, the power transmission belt 125 of the second-stage extendable and retractable arm 122₂moves the first connecting member between the third-stage extendable and retractable arm 122₃and the second-stage extendable and retractable arm 122₂along therewith in the horizontal direction. As a result, the third-stage extendable and retractable arm 122₃, to which the other end of the first connecting member is fixed, extends and retracts in the horizontal direction with respect to the second-stage extendable and retractable arm 122₂.

The pick-up part 13 is mounted on the tip of the third stage extendable and retractable arm 122₃in the horizontal direction.

Thus, out of the N-stage extendable and retractable arms 122 in the extendable and retractable unit 12, the first-stage extendable and retractable arm 122₁is mounted on the fixed arm 121 slidably in the horizontal direction, and the nth-stage extendable and retractable arm 122ₙ (1 < n ≤ N) is mounted on the (n-1)th-stage extendable and retractable arm 122ₙ₋₁ slidably in the horizontal direction.

The extension and retraction operation of the N-stage extendable and retractable arms 122 in the horizontal direction are in conjunction with each other. In other words, when the motor 123 drives the first-stage extendable and retractable arm 122₁to extend the first-stage extendable and retractable arm 122₁in the horizontal direction with respect to the fixed arm 121, the other extendable and retractable arm 122 on each stage also synchronously extends in the horizontal direction with respect to the extendable and retractable arm 122 on the previous stage. When the motor 123 drives the first-stage extendable and retractable arm 122₁to retract the first-stage extendable and retractable arm 122₁in the horizontal direction with respect to the fixed arm 121, the other extendable and retractable arm 122 on each stage also synchronously retracts in the horizontal direction with respect to the extendable and retractable arm 122 on the previous stage.

The principle of the synchronized extension and retraction operation in the extendable and retractable unit 12 will be described. The motor 123 moves the first-stage extendable and retractable arm 122₁via the power transmission belt 125 provided on the fixed arm 121. The movement of the first-stage extendable and retractable arm 122₁changes the relative positional relation between the first-stage extendable and retractable arm 122₁and the fixed arm 121 and the motor 123. This change in the relative positional relation is used to rotate the power transmission belt 125 of the first-stage extendable and retractable arm 122₁. The rotation of the power transmission belt 125 of the first-stage extendable and retractable arm 122₁moves the second-stage extendable and retractable arm 122₂. The movement of the second-stage extendable and retractable arm 122₂changes the relative positional relation between the second-stage extendable and retractable arm 122₂and the first-stage extendable and retractable arm 122₁. This change in the relative positional relation is used to rotate the power transmission belt 125 of the second-stage extendable and retractable arm 122₂. Furthermore, the rotation of the power transmission belt 125 of the second-stage extendable and retractable arm 122₂moves the third-stage extendable and retractable arm 122₃.

That is, the change in the relative position between the latter-stage arm and the former-stage arm caused by moving the latter-stage arm is used to move the belt provided on the latter-stage arm, and the movement of the belt drives the further-latter-stage arm. This principle can achieve the synchronized extension and retraction operation in the extendable and retractable unit 12.

As illustrated in FIG. 3A, when the extendable and retractable arms 122 are not extended in the horizontal direction (a retracted state), the extendable and retractable arms 122 and the fixed arm 121 are folded and arranged in the up and down direction.

The extendable and retractable arms 122 have an approximately equal length in the horizontal direction. Each of the extendable and retractable arms 122 and the fixed arm 121 have an approximately equal length in the horizontal direction. As illustrated in FIG. 3A, when the extendable and retractable arms 122 are not extended in the horizontal direction, the ends of the respective extendable and retractable arms 122 and the fixed arm 121 on one side in the horizontal direction are approximately aligned with each other and the ends on the other side in the horizontal direction are also approximately aligned with each other, and the entire extendable and retractable unit 12 occupies a small space in the horizontal direction.

The motor 123 is mounted on the fixed arm 121. In the present embodiment, one motor 123 is provided, and the one motor 123 is mounted on the fixed arm 121 via a bracket not illustrated.

The motor 123 provides driving force for the extension and retraction of the extendable and retractable unit 12 in the horizontal direction. When the motor 123 rotates in one direction, the extendable and retractable unit 12 is driven to extend. When the motor 123 rotates in the reverse direction, the extendable and retractable unit 12 is driven to retract.

The pick-up part 13 is mounted on the Nth-stage extendable and retractable arm 122 of the extendable and retractable unit 12, and is specifically mounted on the tip of the Nth-stage extendable and retractable arm 122 (the extendable and retractable arm 122₃ in the example illustrated in FIG. 3B) as illustrated in FIG. 1B and elsewhere. The pick-up part 13 grabs and releases the reagent container 2 under the control of a control unit not illustrated. For example, as illustrated in FIG. 3A and FIG. 3B, the pick-up part 13 has a member 13A mounted on the tip of the Nth-stage extendable and retractable arm 122 and a member 13B provided facing the side of the reagent container 2. The role of the member 13B will be described in a modification.

The control unit is used to control the operation of the apparatus body 11, the extendable and retractable unit 12, and the pick-up part 13.

Specifically, the control unit raises and lowers the mounting bracket 112 in the up and down direction with respect to the body bracket 111 by controlling the operation of the motor 115 of the apparatus body 11, thereby raising and lowering the extendable and retractable unit 12 in the up and down direction. The control unit controls the raising and lowering stroke of the mounting bracket 112 by controlling the amount of operation of the motor 115, thereby controlling the raising and lowering stroke of the extendable and retractable unit 12.

The control unit extends and retracts each extendable and retractable arms 122 in the horizontal direction by controlling the operation of the motor 123 of the extendable and retractable unit 12, thereby moving the pick-up part 13 to a certain position in the horizontal direction. The control unit controls the extension and retraction stroke of the extendable and retractable arms 122 by controlling the amount of operation of the motor 123, thereby moving the pick-up part 13 to a desired position.

FIG. 5 is an illustrative diagram of an example of the configuration of the reagent storage 3 loaded with a plurality of rounds of reagent containers. In the example illustrated in FIG. 5, the reagent storage 3 has a reagent storage body 31 that stores reagent containers. In the reagent storage body 31, an inner circumferential loading board Inner on the inner side in the radial direction (corresponding to the horizontal direction) and an outer circumferential loading board Outer on the outer side are formed as areas for storing reagent containers. The inner circumferential loading board Inner and the outer circumferential loading board Outer are each provided with a plurality of loading positions for loading reagent containers, spaced in the circumferential direction. The reagent storage 3 is configured such that the inner circumferential loading board Inner and the outer circumferential loading board Outer can each independently rotate about a rotational center O. The reagent storage body 31 has a reagent storage opening 32 connecting the inside and the outside to each other. Furthermore, the reagent storage 3 has a drive unit that rotationally drives the inner circumferential loading board Inner and the outer circumferential loading board Outer, and drives by the drive unit such that any loading position in the inner circumferential loading board Inner or the outer circumferential loading board Outer faces the reagent storage opening 32, thereby allowing the loading apparatus 1 to take out and take in the reagent container from and to the loading position via the reagent storage opening 32.

The control unit controls the operation of the motor 123 to extend the extendable and retractable arms 122 in the direction of the rotational center O of the reagent storage 3 along the radial direction of the reagent storage 3 (refer to the double-pointed arrow in FIG. 5) with a desired stroke, and can move the pick-up part 13 to a position at which the reagent container can be taken out and taken in from and to a certain loading position in the outer circumferential loading board Outer or the inner circumferential loading board Inner of the reagent storage 3.

Of course, the reagent storage 3 illustrated in FIG. 5 is only by way of example, and the scope of application of the loading apparatus 1 according to the present embodiment is not limited to this. For example, the reagent storage 3 may store three or more rounds of reagent containers. The loading apparatus 1 can accommodate even such a configuration.

The control unit also controls the operation of the pick-up part 13 to grab or release the reagent container.

### Operation Example

Next, the operation of the loading apparatus 1 according to the first embodiment will be described.

It is now assumed that the reagent storage 3 with the configuration illustrated in FIG. 5 is used, the loading apparatus 1 is provided on the side of the reagent storage 3, and the pick-up part 13 faces the reagent storage opening 32 of the reagent storage 3. At this time, it is also assumed that in the reagent storage 3, a certain loading position in the loading board (the inner circumferential loading board Inner or the outer circumferential loading board Outer) from and to which the reagent container is taken out and taken in faces the reagent storage opening 32.

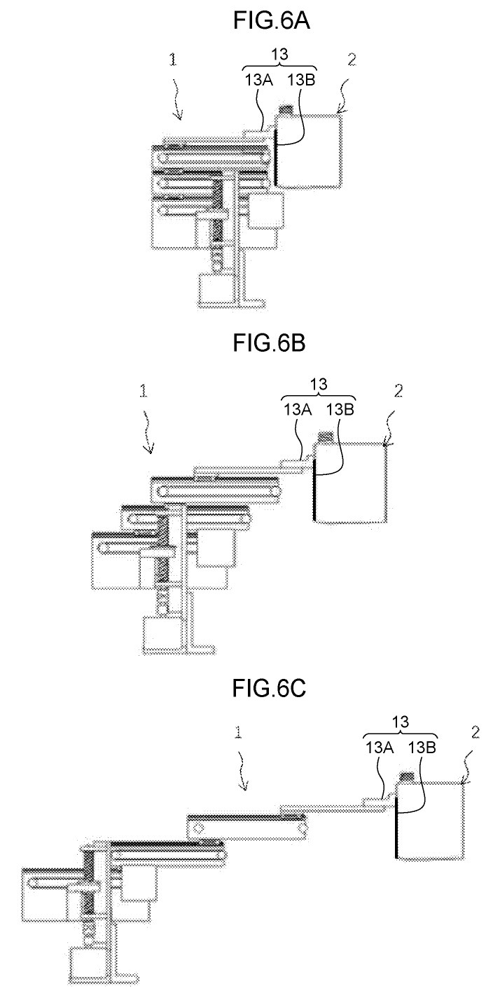

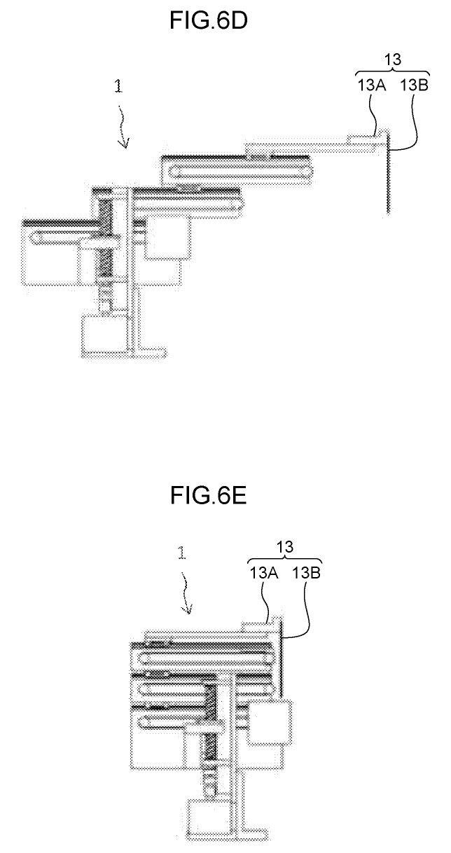

FIG. 6A to FIG. 6E are illustrative diagrams of the operation of the loading apparatus 1 during a process of taking in the reagent container 2 to the reagent storage 3 by the loading apparatus 1 according to the present embodiment.

To take in the reagent container 2 to the reagent storage 3, first, as illustrated in FIG. 6A, the control unit of the loading apparatus 1 controls the pick-up part 13 to grab the reagent container 2 and also controls the motor 115 of the apparatus body 11 to adjust the extendable and retractable unit 12 to an appropriate height.

Then, as illustrated in FIG. 6B and FIG. 6C, the control unit of the loading apparatus 1 extends the extendable and retractable unit 12 with a stroke corresponding to the loading board to which the reagent container 2 is taken in, so that the pick-up part 13 reaches the certain loading position in the loading board via the reagent storage opening 32 as illustrated in FIG. 6C. At this time, the control unit of the loading apparatus 1 controls the pick-up part 13 to take in the reagent container 2 to the loading position.

Finally, as illustrated in FIG. 6D, the control unit of the loading apparatus 1 retracts the extendable and retractable unit 12, so that the extendable and retractable unit 12 eventually retracts to the state illustrated in FIG. 6E (a retracted state).

To take out the reagent container 2 from the reagent storage 3, an operation opposite to that of taking in the reagent container 2 to the reagent storage 3 may be performed. That is, first, in FIG. 6E, the control unit of the loading apparatus 1 controls the motor 115 of the apparatus body 11 to adjust the extendable and retractable unit 12 to an appropriate height.

Then, referring to FIG. 6D, the control unit of the loading apparatus 1 extends the extendable and retractable unit 12 with a stroke corresponding to the loading board from which the reagent container 2 is taken out, so that the pick-up part 13 reaches the certain loading position in the loading board from which the reagent container 2 is taken out via the reagent storage opening 32.

Then, in FIG. 6C, the control unit of the loading apparatus 1 controls the pick-up part 13 to grab the reagent container 2 from the certain loading position.

Finally, in FIG. 6B, the control unit of the loading apparatus 1 retracts the extendable and retractable unit 12, so that the extendable and retractable unit 12 eventually retracts to the state illustrated in FIG. 6A (a retracted state).

As described above, in the loading apparatus 1, the reagent container 2 is taken out and taken in from and to the reagent storage 3 using the pick-up part 13 by extending the extendable and retractable unit 12 in the direction of the rotational center O of the reagent storage 3.

In the loading apparatus 1, the extendable and retractable unit 12 extends to any loading board out of the two or more rounds of loading boards inside the reagent storage 3 in the direction of the rotational center O of the reagent storage 3, and can take out and take in the reagent container 2 from and to the reagent storage 3 using the pick-up part 13.

### Main Effects

As described above, the loading apparatus 1 according to the first embodiment is a loading apparatus for taking out and taking in the reagent container from and to the rotatable reagent storage of the automatic analysis apparatus, and includes the pick-up part 13 (the holding part) and the extending the extendable and retractable unit 12. The pick-up part 13 is a member for holding the reagent container 2. The extendable and retractable unit 12 has two- or more-stage arms that are extendable and retractable in the direction of the rotational center of the reagent storage 3. The pick-up part 13 is provided at one end of the two- or more-stage extendable and retractable unit 12. In the loading apparatus 1, the reagent container 2 is taken out and taken in from and to the reagent storage 3 using the pick-up part 13 by extending the extendable and retractable unit 12 in the direction of the rotational center of the reagent storage 3.

According to the present embodiment, the loading apparatus 1 takes out and takes in the reagent container by extending the extendable and retractable unit 12 in the direction of the rotational center O of the reagent storage 3. That is, the loading apparatus 1 can be installed on the side of the reagent storage 3 to access the reagent storage along the radial direction of the reagent storage, eliminating the need to use the space above the reagent storage and enabling the space above the reagent storage to be used for the placement of another unit. Therefore, compared to conventional loading apparatuses that occupy the space above the reagent storage, it can contribute to improvement in the layout of the entire system.

According to the present embodiment, the extendable and retractable unit 12 has two- or more-stage arms that are extendable and retractable in the direction of the rotational center O of the reagent storage 3, thus ensuring a comparatively large operating stroke when extended and occupying a comparatively small space when retracted. Therefore, it is possible to accommodate the reagent storage loaded with a plurality of rounds of reagent containers, with a downsized configuration.

According to the present embodiment, the configuration of the multi-stage extendable and retractable arms 122 can lengthen the operating stroke of the loading apparatus 1 in the horizontal direction. This enables the pick-up part 13 to operate in a wide range from a position near the apparatus body 11 to a position far from the apparatus body 11 in the horizontal direction. Thus, it is possible to achieve taking out and taking in of the reagent container from and to the reagent storage loaded with a plurality of rounds of reagent containers.

According to the present embodiment, the extendable and retractable arms 122 of the extendable and retractable unit 12 are provided in multiple stages (at least two stages), so that the loading apparatus 1 occupies a relatively small space in the horizontal direction when the extendable and retractable arms 122 are in the retracted state. Thus, downsizing of the loading apparatus 1 can be achieved.

In the loading apparatus 1 according to the first embodiment, two or more rounds of loading boards that load the reagent container 2 are provided inside the reagent storage 3. The extendable and retractable unit 12 extends to any loading board out of the two or more rounds of loading boards inside the reagent storage 3 in the direction of the rotational center of the reagent storage 3 to take out and take in the reagent container 2 from and to the any loading board using the pick-up part 13. The present embodiment can accommodate the reagent storage 3 loaded with a plurality of rounds of reagent containers 2.

In the loading apparatus 1 according to the first embodiment, the two- or more-stage arms (the extendable and retractable arms 122) extend and retract in conjunction with each other. The present embodiment can shorten the time for the extension and retraction operation of the multi-stage arms. Thus, the diagnostic speed of the automatic analysis system including the loading apparatus 1 can be improved.

In the loading apparatus 1 according to the first embodiment, the two- or more-stage arms (the extendable and retractable arms 122) are folded and arranged in the retracted state of the extendable and retractable unit 12. As an example, in the retracted state of the extendable and retractable unit 12, the two- or more-stage arms are folded and arranged in the height direction crossing the extension and retraction direction of the extendable and retractable unit. The present embodiment can achieve downsizing of the loading apparatus.

In the loading apparatus 1 according to the first embodiment, the two- or more-stage arms (the extendable and retractable arms 122) are equal in length in the extension and retraction direction of the extendable and retractable unit 12, and respective both ends of the two- or more-stage arms in the extension and retraction direction are aligned with each other in the retracted state of the extendable and retractable unit 12. According to the present embodiment, the space occupied in the retracted state is smaller than in the case of different arm lengths, and thus downsizing of the loading apparatus can be achieved.

The loading apparatus 1 according to the first embodiment has the apparatus body 11, and the extendable and retractable unit 12 is provided relatively movably with respect to the apparatus body 11 in a height direction crossing the extension and retraction direction of the extendable and retractable unit 12. According to the present embodiment, with the above configuration, the pick-up part 13 (the holding part) can release the reagent container 2 after entering the reagent storage 3 and being further lowered with a certain stroke. Thus, since the shaking of the reagent container 2 can be reduced, it is possible to avoid bubbling of the reagent causing misdiagnoses, and it is also possible to avoid splattering of the reagent or toppling over of the reagent bottle (the reagent container 2).

### First Modification of First Embodiment

### Configuration

The configuration of the loading apparatus 1 according to a first modification of the first embodiment will be described below.

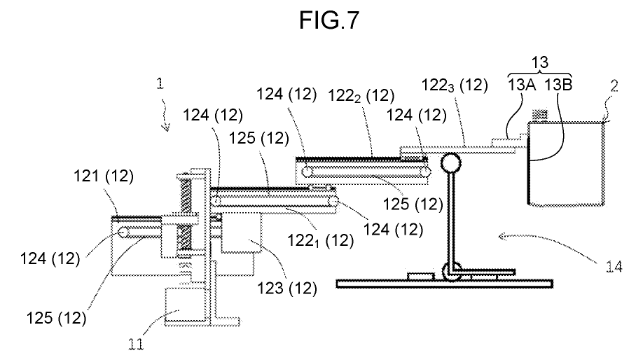

FIG. 7 is an illustrative diagram of the configuration of the loading apparatus 1 according to the first modification of the first embodiment. As illustrated in FIG. 7, the loading apparatus 1 according to the first modification differs from the loading apparatus 1 according to the first embodiment in that a support unit 14 that supports the expandable and retractable arms 122 is added.

As illustrated in FIG. 7, the support unit 14 as a whole is positioned below the path in which the extendable and retractable arms 122 of the extendable and retractable unit 12 extend and retract in the horizontal direction. For example, the support unit 14 may be provided below the path in which only the Nth-stage (final-stage) extendable and retractable arm 122 out of the N-stage extendable and retractable arms 122 extends and retracts in the horizontal direction to support only the Nth-stage extendable and retractable arm 122.

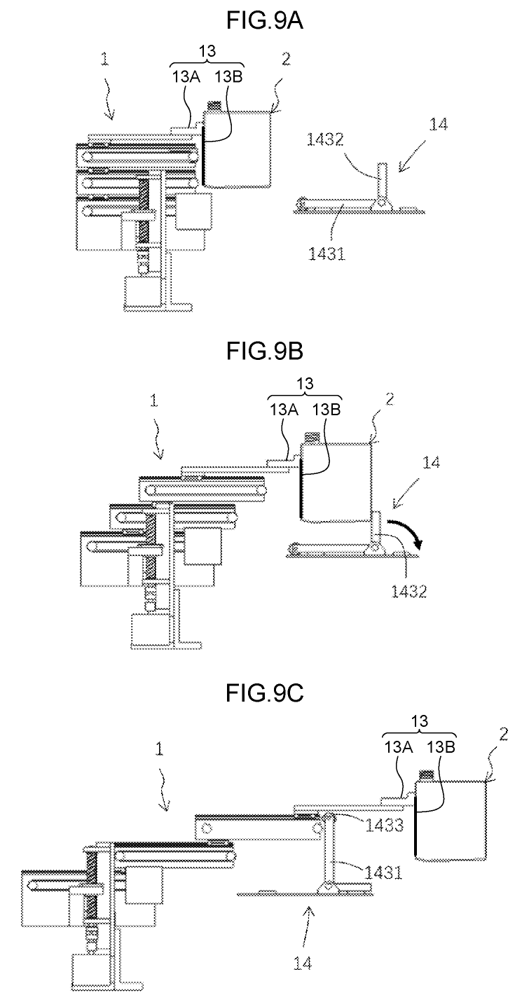

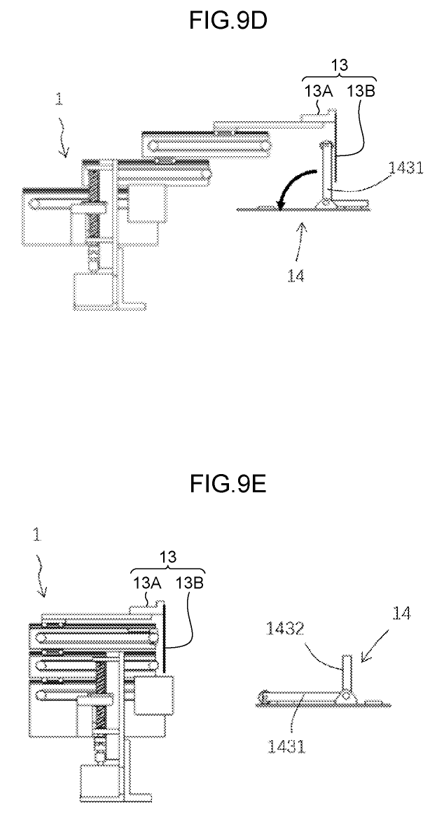

The support unit 14 is configured to switch between a supporting state, which supports the extendable and retractable arms 122 (refer to FIG. 9C), and a non-supporting state, which does not support the extendable and retractable arms 122 (refer to FIG. 9E), in conjunction with each of an extension operation and a retraction operation of the extendable and retractable arms 122 along the horizontal direction. In other words, when the extendable and retractable arms 122 extend along the horizontal direction, the support unit 14 is switched to the supporting state to support the extendable and retractable arms 122 positioned above it. On the other hand, when the extendable and retractable arms 122 retract along the horizontal direction, the support unit 14 is switched to the non-supporting state.

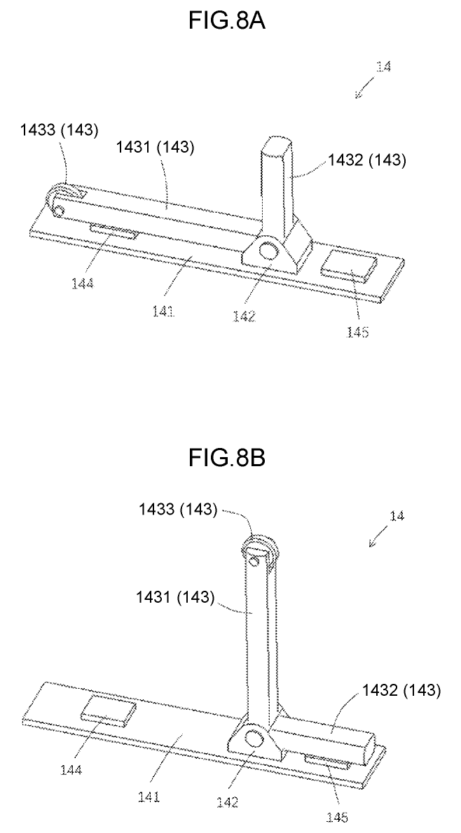

FIG. 8A and FIG. 8B are illustrative diagrams of the configuration of the support unit 14. Here, FIG. 8A illustrates the non-supporting state and FIG. 8B illustrates the supporting state.

As illustrated in these figures, the support unit 14 has a base 141 and a support 143.

The base 141 is positioned below the extension and retraction path of the extendable and retractable arms 122 of the extendable and retractable unit 12 in the horizontal direction. The base 141 is provided with a pivot axis 142.

The support 143 is mounted on the base 141 via the pivot axis 142 rotatably about a certain axis crossing the extension and retraction direction of the extendable and retractable arms 122 and the up and down direction.

The support 143 has a support arm 1431 and an escape arm 1432. The support arm 1431 and the escape arm 1432 are coupled to each other to be L-shaped, thereby forming the support 143 in an L shape as a whole.

The support arm 1431 can be switched between a fallen attitude, which does not support the extendable and retractable arms 122, and an erect attitude, which supports the extendable and retractable arms 122. A roller 1433 (an example of a "low-friction part") is rotatably mounted on the opposite end of the support arm 1431 from the side coupled to the escape arm 1432. When the support arm 1431 is switched to the erect attitude, the roller 1433 at the tip of the support arm 1431 comes into contact with the underside of the extendable and retractable arms 122 to support extendable and retractable arms 122. Thus, when the extendable and retractable arms 122 slide on the roller 1433 in extension and retraction, using the property that the coefficient of friction between the roller 1433 and the extendable and retractable arms 122 is relatively low and friction is relatively small, wear on the extendable and retractable arms 122 is reduced.

Similar to the support arm 1431, the escape arm 1432 can also be switched between a fallen attitude and an erect attitude. However, it differs from the support arm 1431 in that it does not support the extendable and retractable arms 122, whether in the fallen attitude or the erect attitude. Thus, the escape arm 1432 is formed to have a shorter length than the total length of the support arm 1431 and the roller 1433.

When the extendable and retractable unit 12 extends along the horizontal direction, when the pick-up part 13 at the tip of the extendable and retractable arms 122 or the reagent container 2 held thereby comes into contact with the escape arm 1432 in the erect attitude, the escape arm 1432 rotates under the action of a pressing force by the pick-up part 13 or the reagent container 2 held thereby, and is switched from the erect attitude to the fallen attitude. At the same time, the support arm 1431 rotates along with the rotation of the escape arm 1432, and is switched from the fallen attitude to the erect attitude (FIG. 9B to FIG. 9C).

When the extendable and retractable unit 12 retracts along the horizontal direction, when the pick-up part 13 at the tip of the extendable and retractable arms 122 or the reagent container 2 held thereby comes into contact with the support arm 1431 in the erect attitude, the support arm 1431 rotates under the action of a pressing force by the pick-up part 13 or the reagent container 2 held thereby, and is switched from the erect attitude to the fallen attitude. At the same time, the escape arm 1432 rotates along with the rotation of the support arm 1431, and is switched from the fallen attitude to the erect attitude (FIG. 9D to FIG. 9E).

As illustrated in FIG. 8A and FIG. 8B, the support unit 14 further has magnets 144 and 145 (an example of an "attitude holding part"). The magnet 144 is a permanent magnet, is provided at a position corresponding to the support arm 1431 in the base 141, and attracts the support arm 1431 when the support arm 1431 is in the fallen attitude. The magnet 145 is a permanent magnet, is provided at a position corresponding to the escape arm 1432 in the base 141, and attracts the escape arm 1432 when the escape arm 1432 is in the fallen attitude. For this purpose, the support arm 1431 and the escape arm 1432 are made of a magnetic metal material. Thus, when the support arm 1431 is in the fallen attitude, the magnet 144 attracts the support arm 1431, thereby holding the currently presented attitude of the support arm 1431, that is, the fallen attitude with a certain magnitude of force. On the other hand, when the support arm 1431 is in the erect attitude, the magnet 145 attracts the escape arm 1432, thereby holding the currently presented attitude of the support arm 1431, that is, the erect attitude with a certain magnitude of force.

Note that the certain magnitude of force at which the magnets 144 and 145 hold the current attitude of the support arm 1431 is set to be of such magnitude that when the extendable and retractable unit 12 extends and retracts along the horizontal direction, the pick-up part 13 at the tip of the extendable and retractable arms 122 or the reagent container 2 held by the pick-up part 13 can push the support arm 1431 or the escape arm 1432 against the certain magnitude of force, thereby switching the support arm 1431 from one of the fallen attitude and the erect attitude to the other.

The other configurations of the loading apparatus 1 according to the first modification of the first embodiment are the same as those of the first embodiment.

### Operation Example

Next, the operation of the loading apparatus 1 according to the first modification of the first embodiment will be described.

FIG. 9A to FIG. 9E illustrate the operation of the loading apparatus 1 when the reagent container 2 is taken in to the reagent storage 3.

As illustrated in FIG. 9A, when the extendable and retractable unit 12 is not extended, the support unit 14 is in the non-supporting state, in which the support arm 1431 of the support 143 falls and the escape arm 1432 is erected.

As illustrated in FIG. 9B, when the extendable and retractable unit 12 extends and the reagent container 2 held by the pick-up part 13 at the tip of the extendable and retractable arms 122 pushes the escape arm 1432 of the support 143, the support 143 rotates about a certain axis as in the arrow in FIG. 9B. As a result, as illustrated in FIG. 9C, the support unit 14 is switched to the supporting state, in which the support arm 1431 of the support 143 is erected and the escape arm 1432 falls, supporting the extendable and retractable arms 122 by the support arm 1431 of the support 143.

As illustrated in FIG. 9D, after the loading apparatus 1 takes in the reagent container 2 into the reagent storage 3, when the extendable and retractable unit 12 retracts, and the pick-up part 13 (specifically, the member 13B) at the tip of the extendable and retractable arms 122 pushes the support arm 1431 of the support 143, the support 143 rotates about a certain axis as in arrow in FIG. 9D. As a result, as illustrated in FIG. 9E, the support unit 14 is switched to the non-supporting state, in which the support arm 1431 of the support 143 falls and the escape arm 1432 is erected, no longer supporting the extendable and retractable arms 122.

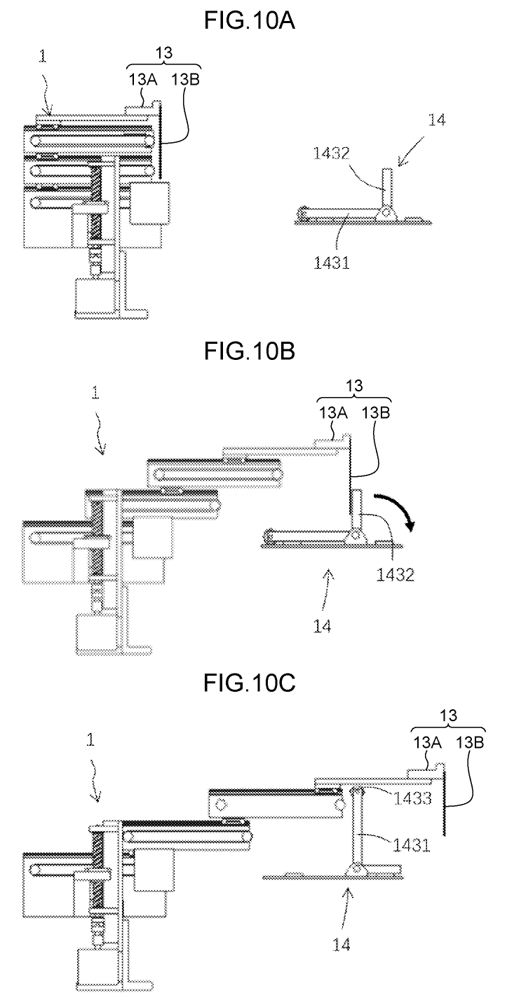

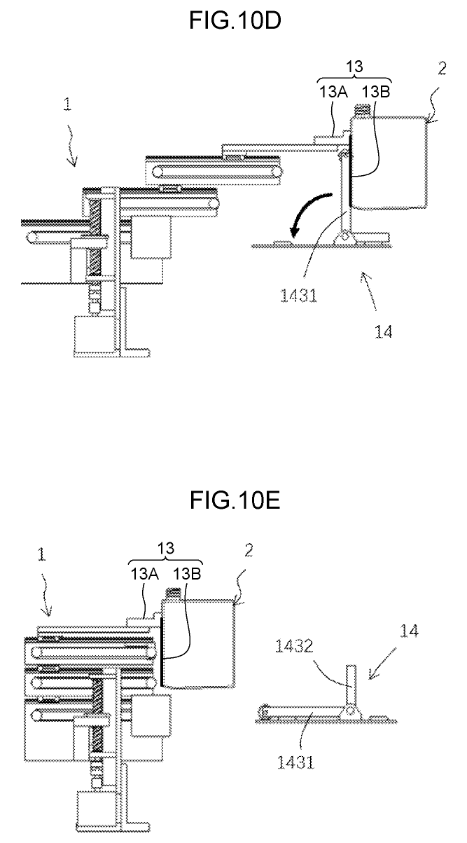

FIG. 10A to FIG. 10E illustrate the operation of the loading apparatus 1 when the reagent container 2 is taken out from the reagent storage 3.

As illustrated in FIG. 10A, when the extendable and retractable unit 12 is not extended, the support unit 14 is in the non-supporting state, in which the support arm 1431 of the support 143 falls and the escape arm 1432 is erected.

As illustrated in FIG. 10B, when the extendable and retractable unit 12 extends and the pick-up part 13 (specifically, the member 13B) at the tip of the extendable and retractable arms 122 pushes the escape arm 1432 of the support 143, the support 143 rotates about a certain axis as in the arrow in FIG. 10B. As a result, as illustrated in FIG. 10C, the support unit 14 is switched to the supporting state, in which the support arm 1431 of the support 143 is erected and the escape arm 1432 falls, supporting the extendable and retractable arms 122 by the support arm 1431 of the support 143.

As illustrated in FIG. 10D, after the pick-up part 13 grabs the reagent container 2 from the reagent storage 3, when the extendable and retractable unit 12 retracts, and the pick-up part 13 (specifically, the member 13B ) at the tip of the extendable and retractable arms 122 of the extendable and retractable unit 12 pushes the support arm 1431 of the support 143, the support 143 rotates around a certain axis as in the arrow in FIG. 10D. As a result, as illustrated in FIG. 10E, the support unit 14 is switched to the non-supporting state, in which the support arm 1431 of the support 143 falls and the escape arm 1432 is erected.

### Main Effects

As described above, the loading apparatus 1 according to the first modification of the first embodiment has the support unit 14 that is switched to the supporting state, which supports the extendable and retractable arms 122, or the non-supporting state, which does not support the extendable and retractable arms 122, in conjunction with the extension and retraction of the extendable and retractable unit 12.

According to the first modification of the first embodiment, in addition to the effects of the first embodiment, the support unit 14 can improve the structural rigidity of the multi-stage extendable and retractable arms 122 of the extendable and retractable unit 12 in the extended state, which can improve the stability of the operation of the multi-stage extendable and retractable arms 122 in the extended state. Thus, since the shaking of the extendable and retractable arms 122 during operation can be fundamentally reduced, it is possible to avoid bubbling of the reagent due to violent shaking of the reagent container causing misdiagnoses, and it is also possible to avoid splattering of the reagent or spilling of the reagent due to toppling over of the reagent container due to violent shaking of the reagent container leading to waste.

In the loading apparatus 1 according to the first modification of the first embodiment, the support unit 14 supports only the arm provided with the pick-up part 13 out of the two- or more-stage arms (the extendable and retractable arms 122). According to the first modification of the first embodiment, the stability of the operation of the multi-stage arms in the extended state can be improved, and at the same time, the complexity of the overall structure of the loading apparatus can be avoided.

In the loading apparatus 1 according to the first modification of the first embodiment, the support unit 14 has the support 143. The support 143 is rotatably provided below the extension and retraction path of the extendable and retractable arms 122, and has the support arm 1431 that becomes the fallen attitude in the non-supporting state and becomes the erect attitude in the supporting state, and the escape arm 1432 coupled to the support arm 1431 in an L shape. In the process in which the extendable and retractable unit 12 extends, the support 143 rotates by the escape arm 1432 being pushed by the pick-up part 13 or the reagent container (2) held by the pick-up part 13, by which the support arm 1431 becomes the erect attitude to support the extendable and retractable arms 122. In the process in which the extendable and retractable unit 12 retracts, the support 143 rotates by the support arm 1431 being pushed by the pick-up part 13 or the reagent container 2 held by the pick-up part 13, by which the support arm 1431 becomes the fallen attitude.

According to the first modification of the first embodiment, supporting of the arms by the extendable and retractable unit 12 can be achieved simply by using the L-shaped support 143. In addition, there is no need to install an independent drive mechanism to provide driving force, and the support 143 can be switched between the supporting state (the erect attitude) and the non-supporting state (the fallen attitude) simply by the pressing of the support 143 by the arms when they extend and retract in the horizontal direction. Therefore, the support unit 14 can be achieved with a simple structure, and downsizing of the entire loading apparatus can be achieved.

In the loading apparatus 1 according to the first modification of the first embodiment, the contact part of the support arm 1431 that comes into contact with the extendable and retractable arms 122 to support the extendable and retractable arms 122 is the low-friction part with a lower coefficient of friction with the extendable and retractable arms 122 than other parts. The roller 1433 rotatably provided in the support arm 1431 may be used as such a low-friction part. The first modification of the first embodiment can reduce wear on the arms of the extendable and retractable unit 12 by the support arm 1431.

In the loading apparatus 1 according to the first modification of the first embodiment, the support unit 14 has the attitude holding part that holds the fallen attitude or the erect attitude that is currently presented of the support arm 1431 of the support 143 with a certain magnitude of force. The pick-up part 13 or the reagent container 2 held thereby exerts a pressing force of a magnitude that can counter the above force on the support arm 1431 or the escape arm 1432 in the extension and retraction of the extendable and retractable unit 12.

The first modification of the first embodiment can improve the stability of the support unit 14 in each state, and thus the stability of the operation of the extended state of the arms of the extendable and retractable unit 12 supported by the support unit 14 by holding the fallen attitude or the erect attitude that is currently presented of the support arm 1431 with a certain magnitude of force. Thus, since the shaking of the arms of the extendable and retractable unit 12 during operation can be more surely reduced, it is possible to avoid bubbling of the reagent due to violent shaking of the reagent container 2 causing misdiagnoses, and it is also possible to avoid splattering of the reagent or spilling of the reagent due to toppling over of the reagent container due to violent shaking of the reagent container 2 leading to waste.

In the loading apparatus 1 according to the first modification of the first embodiment, the attitude holding part is the magnets 144 and 145, and the support arm 1431 and the escape arm 1432 are made of a magnetic metal material. The first modification of the first embodiment can contribute to simplification of the structure of the loading apparatus.

### Second Modification of First embodiment

### Configuration

The configuration of the loading apparatus 1 according to a second modification of the first embodiment will be described below.

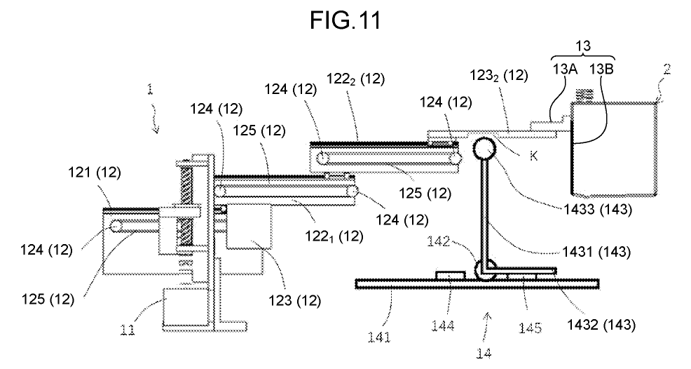

FIG. 11 is an illustrative diagram of the configuration of the loading apparatus 1 according to the second modification of the first embodiment. As illustrated in FIG. 11, the loading apparatus 1 according to the second modification differs from the loading apparatus 1 according to the first modification in that a recess K (a downward recess) is formed downward in the extendable and retractable arm 122 supported by the support unit 14 out of the multi-stage extendable and retractable arms 122 of the extendable and retractable unit 12.

As illustrated in FIG. 11, the recess K is formed on the underside of the extendable and retractable arm 122 that is farthest from the apparatus body 11 in the extended state of the extendable and retractable unit 12.

The position of the recess K formed on the underside of the extendable and retractable arm 122 is set such that when the extendable and retractable arms 122 of the extendable and retractable unit 12 extend to a state in which the reagent container 2 is taken in to the reagent storage 3 by the pick-up part 13 or when they extend to a state in which the reagent container 2 can be taken out from the reagent storage 3, the recess K is positioned above the part of the support unit 14 that supports the extendable and retractable arm 122 (that is, the roller 1433).

The recess K is set with a depth such that the extendable and retractable unit 12, when lowered, does not interfere with the part of the support unit 14 that supports the extendable and retractable arm 122 and that the bottom of the recess K comes into contact with the part of the support unit 14 that supports the extendable and retractable arm 122 after completion of the lowering of the extendable and retractable unit 12.

Note that one or a plurality of recesses K may be provided as needed.

The other configurations of the loading apparatus 1 according to the second modification of the first embodiment are the same as those of the first modification.

### Operation Example

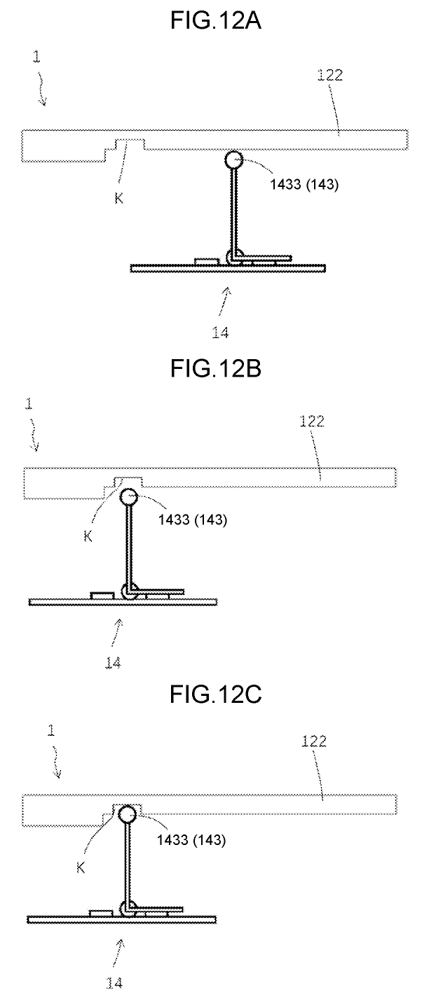

FIG. 12A to FIG. 12C are illustrative diagrams of a supporting situation of the extendable and retractable arm 122 by the support unit 14 in each stage during the process in which the extendable and retractable unit extends in the loading apparatus 1 according to the second modification of the first embodiment.

As illustrated in FIG. 12A, after the extendable and retractable unit 12 extends and the support unit 14 is switched to the supporting state, the roller 1433 at the tip of the support arm 1431 of the support 143 comes into contact with the underside of the extendable and retractable arm 122 of the extendable and retractable unit 12 and rolls on the underside. As a result, the support arm 1431 of the support 143 supports the extendable and retractable arm 122 in the extension of the extendable and retractable arm 122.

As illustrated in FIG. 12B, the extendable and retractable unit 12 stops after extending with a target stroke. At this time, the recess K in the extendable and retractable arm 122 is positioned above the roller 1433 at the tip of the support arm 1431, and the roller 1433 is away from the bottom of the recess K, not supporting the extendable and retractable arm 122.

Then, as illustrated in FIG. 12C, the extendable and retractable unit 12 is lowered with a certain stroke in the up and down direction and then stops. At this time, the roller 1433 at the tip of the support arm 1431 comes into contact with the bottom of the recess K in the extendable and retractable arm 122, again supporting the extendable and retractable arm 122.

The above describes the operation when the extendable and retractable unit 12 extends. When the extendable and retractable unit 12 retracts, an operation opposite to the operation in FIG. 12A to FIG. 12C described above may be performed, and the description thereof is omitted.

### Main Effects

As described above, the loading apparatus 1 according to the second modification of the first embodiment has the apparatus body 11, and the extendable and retractable unit 12 is provided relatively movably with respect to the apparatus body 11 in a height direction crossing the extension and retraction direction of the extendable and retractable unit 12. The downward recess K is formed in the extendable and retractable arm 122 supported by the support unit 14. When the extendable and retractable unit 12 extends to a state in which the reagent container 2 can be taken out and taken in from and to the reagent storage 3, the downward recess K is positioned above the part of the support unit 14 that supports the extendable and retractable arm 122.

According to the second modification of the first embodiment, in addition to the effects of the first modification, by providing the recess K downward in the extendable and retractable arm 122, the extendable and retractable arms 122 can be supported by the support unit 14 not only after the extendable and retractable arms 122 are lowered with a certain stroke in the up and down direction, but also during the process in which the extendable and retractable arms 122 extend and retract in the horizontal direction, and the shaking of the extendable and retractable arms 122 can be reduced.

According to the second modification of the first embodiment, with the above configuration, the pick-up part 13 can release the reagent container 2 after entering the reagent storage 3 and being further lowered with a certain stroke. Thus, since the shaking of the reagent container 2 can be reduced, it is possible to avoid bubbling of the reagent causing misdiagnoses, and it is also possible to avoid splattering of the reagent or toppling over of the reagent bottle (the reagent container 2). By providing the downward recess K in the arm of the extendable and retractable unit 12, it is possible to avoid the arm of the extendable and retractable unit 12 and the support unit 14 from interfering with each other in the lowering of the extendable and retractable unit 12.

### Second Embodiment

### Configuration

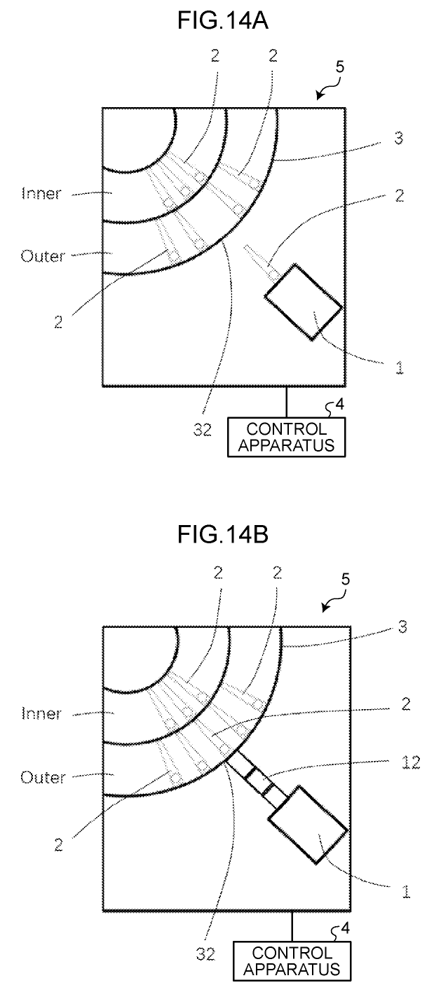

An automatic analysis system 5 according to a second embodiment is an automatic analysis system for performing measurement on a mixed liquid of a test sample and a reagent, and includes an automatic analysis apparatus, the loading apparatus 1, and a control apparatus 4 (an example of a "controller") that controls the entire system (refer to FIGS. 14A, 14B, 15A and 15B).

The automatic analysis apparatus is an apparatus having a function of performing measurement on the mixed liquid of the test sample and the reagent in the automatic analysis system 5 according to the present embodiment.

As described above, the automatic analysis apparatus has the reagent storage 3, and each kind of reagent necessary for the automatic analysis apparatus to perform measurement is placed in the reagent container 2 and stored in the reagent storage 3. The reagent storage 3 has a loading board inside it for the reagent container 2 to be loaded, which can rotate about a rotational center. One or a plurality of loading boards may be provided. When the loading boards are provided, the loading boards with different diameters may be provided concentrically so that they rotate about the rotational center. The reagent storage 3 has the reagent storage opening 32 connecting the inside and the outside of the reagent storage 3 to each other on the side.

The automatic analysis apparatus also has a control unit. For the reagent storage 3, the control unit performs control to open and close the reagent storage opening 32 of the reagent storage 3 and control to rotate the loading board in the reagent storage 3 and to cause its certain loading position to face the reagent storage opening 32. The control unit further performs control to perform measurement on the mixed liquid of the test sample and the reagent.

The loading apparatus is the loading apparatus 1 described in any of the first embodiment, the first modification, and the second modification. The loading apparatus 1 is provided on the side of the reagent storage 3. Specifically, the loading apparatus 1 is provided on the side of the reagent storage 3 so that the extendable and retractable arms 122 of the extendable and retractable unit 12 and the pick-up part 13 provided at the tip thereof can enter and exit the reagent storage 3 via the reagent storage opening 32 in the radial direction of the reagent storage 3 (the radial direction is a direction passing through the rotational center of the loading board and crossing the axis of the rotational center of the loading board, which is also called the radial direction of the loading board). In other words, the reagent storage opening 32 on the side of the reagent storage 3 is provided toward the loading apparatus 1. As described above, the loading apparatus 1 is used to take out and take in the reagent container 2 from and to the reagent storage 3. Specifically, the loading apparatus 1 takes out and takes in the reagent container 2 from and to the reagent storage 3 using the pick-up part 13 by extending the extendable and retractable unit 12 in the direction of the rotational center of the reagent storage 3.

The control apparatus 4 controls the control unit of the loading apparatus 1 and the control unit of the automatic analysis apparatus in general. In this way, the control unit of each of the loading apparatus 1 and the automatic analysis apparatus achieves control of the operation of each of the loading apparatus 1 and the automatic analysis apparatus at each appropriate time. That is, the control apparatus 4, and the control unit of the loading apparatus 1 and the control unit of the automatic analysis apparatus both constitute a controller that performs control for each part in the automatic analysis system 5.

Note that the automatic analysis system 5 may include other apparatuses as needed. In that case, the control apparatus 4 can also control the other apparatuses.

In the automatic analysis system 5 according to the present embodiment, when the reagent container 2 is taken out and taken in from and to the reagent storage 3 by the loading apparatus 1, the processes described below are mainly executed.

In a first process, the control unit of the automatic analysis apparatus, under the control of the control apparatus 4, rotates the reagent storage 3 such that a certain loading position in the loading board faces the reagent storage opening 32.

When one loading board is provided inside the reagent storage 3, the first process performs control such that the certain loading position in the one loading board faces the reagent storage opening 32.

When a plurality of loading boards are provided inside the reagent storage 3, the first process performs control such that the certain loading position in a loading board from and to which the reagent container 2 is taken out and taken in out of the loading boards faces the reagent storage opening 32. More specifically, when the loading board from and to which the reagent container 2 is taken out and taken in is an outermost circumferential loading board in the radial direction out of all the loading boards, the loading board is rotated such that its certain loading position faces the reagent storage opening 32. On the other hand, when the loading board from and to which the reagent container 2 is taken out and taken in is not the outermost circumferential loading board, a loading board on the outside in the radial direction (the outside) of the loading board from and to which the reagent container 2 is taken out and taken in out of the loading boards is rotated such that its vacant position faces the reagent storage opening 32, and the loading board from and to which the reagent container 2 is taken out and taken in is rotated such that its certain loading position faces the reagent storage opening 32.

In the subsequent second process, the control unit of the loading apparatus 1, under the control of the control apparatus 4, extends the extendable and retractable unit 12 of the loading apparatus 1 in the direction of the rotational center of the reagent storage 3 such that the pick-up part 13 of the loading apparatus 1 reaches the certain loading position in the loading board via the reagent storage opening 32 of the reagent storage 3. When one loading board is provided, the pick-up part 13 of the loading apparatus 1 is controlled to reach the certain loading position in the one loading board. When a plurality of loading boards are provided, the extendable and retractable unit 12 of the loading apparatus 1 is extended in the direction of the rotational center of the reagent storage 3 with a stroke corresponding to the loading board from and to which the reagent container 2 is taken out and taken in such that the pick-up part 13 reaches the certain loading position in the loading board from and to which the reagent container 2 is taken out and taken in via the reagent storage opening 32 of the reagent storage 3.

In the subsequent third process, the control unit of the loading apparatus 1, under the control of the control apparatus 4, controls the grabbing and releasing operation of the pick-up part 13 of the loading apparatus 1 to take out and take in the reagent container 2 from and to the certain loading position using the pick-up part 13.

In the subsequent fourth process, the control unit of the loading apparatus 1, under the control of the control apparatus 4, retracts the extendable and retractable unit 12 of the loading apparatus 1 along the radial direction of the reagent storage 3 such that the extendable and retractable unit 12 and the pick-up part 13 at the tip thereof leave the reagent storage 3 via the reagent storage opening 32.

When the height of the extendable and retractable unit 12 of the loading apparatus 1 does not match the height of the reagent storage opening 32 of the reagent storage 3 and cannot be placed in the reagent storage 3 at the initial state, the control unit of the loading apparatus 1, before the second process, under the control of the control apparatus 4, can raise and lower the extendable and retractable unit 12 of the loading apparatus 1 in the up and down direction to a height matching the reagent storage opening 32. The raising and lowering in the up and down direction may be done after the first process, at the same time as the first process, or before the first process. After the extendable and retractable unit 12 and the pick-up part 13 leave the reagent storage 3, the control unit of the loading apparatus 1, under the control of the control apparatus 4, can also raise and lower the extendable and retractable unit 12 of the loading apparatus 1 in the up and down direction to the height of the initial state.

About the support unit 14 of the loading apparatus 1, when the loading apparatus 1 enters the reagent storage 3 in the second process, the support unit 14 of the loading apparatus 1 is switched to the supporting state, in which the support arm 1431 supports the extendable and retractable arms 122 of the loading apparatus 1, in conjunction with the extension operation of the extendable and retractable unit 12. On the other hand, when the loading apparatus 1 leaves the reagent storage 3 in the fourth process, the support unit 14 of the loading apparatus 1 is switched to the non-supporting state, in which it does not support the extendable and retractable arms 122 of the loading apparatus 1, in conjunction with the retraction operation of the extendable and retractable unit 12.

### Operation Example

Next, an operation example of the automatic analysis system 5 according to the second embodiment will be described.

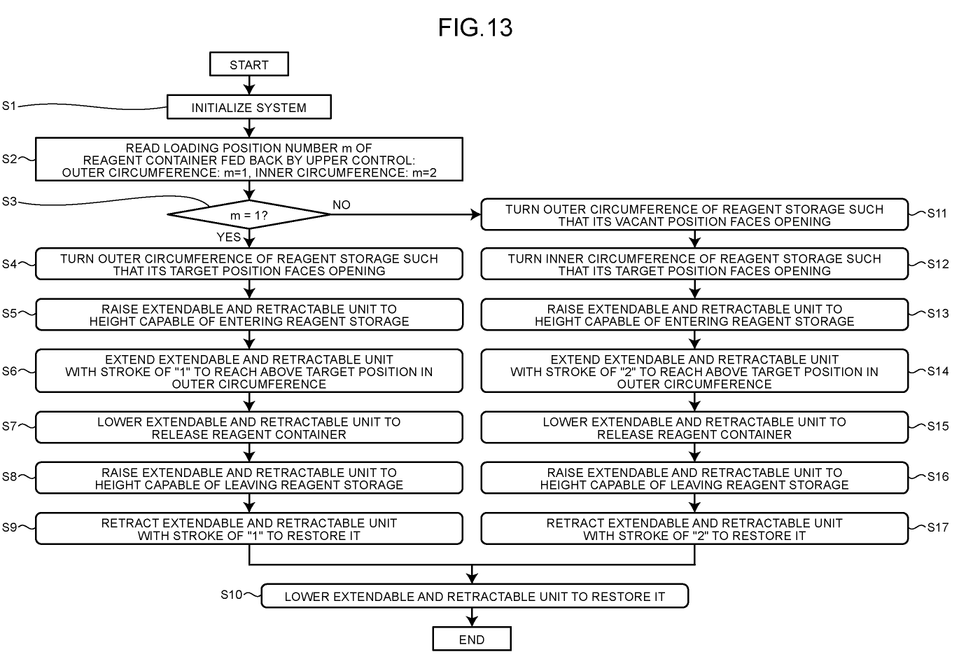

FIG. 13 is a flowchart diagram illustrating the operation of the automatic analysis system 5 according to the second embodiment with a case of the reagent storage 3 loaded with two rounds of reagent containers 2 as an example. FIGS. 14A and 14B are illustrative diagrams of taking in the reagent container to the outer circumference of the reagent storage 3 loaded with two rounds of reagent containers 2 in the automatic analysis system 5. FIGS. 15A and 15B and are illustrative diagrams of taking in the reagent container 2 to the inner circumference of the reagent storage 3 loaded with two rounds of reagent containers 2 in the automatic analysis system 5.

As illustrated in FIG. 13, when starting, the process first moves to Step S1 for initialization.

Then, at Step S2, the control unit of the loading apparatus 1 reads a number m of a loading position in the reagent storage 3 of the reagent container fed back from upper control (here, m = 1 for the outer circumferential loading board Outer (Yes at Step S2) and m = 2 for the inner circumferential loading board Inner (No at Step S2)).

Subsequently, at Step S3, the control unit of the loading apparatus 1 determines whether m = 1 is satisfied based on the information read at Step S2. If it is determined that it is satisfied, the process moves to Step S4. On the other hand, if it is determined that it is not satisfied, the process moves to Step S11.

At Step S4, to take in the reagent container to the outer circumferential loading board Outer of the reagent storage 3, the drive unit of the reagent storage 3 is controlled such that the certain loading position in the outer circumferential loading board Outer faces the reagent storage opening 32 as illustrated in FIG. 14A.

Then, at Step S5, the control unit of the loading apparatus 1 controls the motor 115 of the apparatus body 11 so as to raise the extendable and retractable unit 12 in the up and down direction to a height at which the reagent container 2 and the pick-up part 13 can enter the reagent storage 3 via the reagent storage opening 32.

Then, at Step S6, the control unit of the loading apparatus 1 controls the motor 123 of the extendable and retractable unit 12 such that the extendable and retractable unit 12 extends with a stroke of "1" and stops when the reagent container 2 reaches above the certain loading position in the outer circumferential loading board Outer as illustrated in FIG. 14B.

Then, at Step S7, the control unit of the loading apparatus 1 controls the motor 115 of the apparatus body 11 so as to lower the extendable and retractable unit 12 in the up and down direction to a height at which the reagent container 2 can be taken in to the certain loading position in the outer circumferential loading board Outer of the reagent storage 3. Then, the control unit of the loading apparatus 1 controls the pick-up part 13 so as to take in the reagent container 2 held by the pick-up part 13 to the certain loading position in the outer circumferential loading board Outer.

Then, at Step S8, the control unit of the loading apparatus 1 controls the motor 115 of the apparatus body 11 so as to raise the extendable and retractable unit 12 in the up and down direction to a height at which the pick-up part 13 can leave the reagent storage 3 via the reagent storage opening 32.

Then, at Step S9, the control unit of the loading apparatus 1 controls the motor 123 of the extendable and retractable unit 12 so as to retract the extendable and retractable unit 12 to its initial length along the horizontal direction, that is, so as to retract the extendable and retractable unit 12 with a stroke of "1".

Finally, at Step S10, the control unit of the loading apparatus 1 controls the motor 115 of the apparatus body 11 so as to lower the extendable and retractable unit 12 to its initial height along the up and down direction.

As described above, if it is determined at Step S3 that m = 1 is not satisfied, the process moves to Step S11. At Step S11, to take in the reagent container 2 to the certain loading position in the inner circumferential loading board Inner of the reagent storage 3, the drive unit of the reagent storage 3 is controlled such that a vacant position in the outer circumferential loading board Outer faces the reagent storage opening 32 as illustrated in FIG. 15A. Here, the "vacant position" means a position not loaded with the reagent container in the loading board.

Then, moving to Step S12, the drive unit of the reagent storage 3 is controlled such that the certain loading position in the inner circumferential loading board Inner faces the reagent storage opening 32 as illustrated in FIG. 15A.

Then, at Step S13, the control unit of the loading apparatus 1 controls the motor 115 of the apparatus body 11 so as to raise the extendable and retractable unit 12 in the up and down direction to a height at which the reagent container 2 and the pick-up part 13 can enter the reagent storage 3 via the reagent storage opening 32.

Then, at Step S14, the control unit of the loading apparatus 1 controls the motor 123 of the extendable and retractable unit 12 such that the extendable and retractable unit 12 extends with a stroke of "2" and stops when the reagent container 2 reaches above the certain loading position in the inner circumferential loading board Inner as illustrated in FIG. 15B.

Then, at Step S15, the control unit of the loading apparatus 1 controls the motor 115 of the apparatus body 11 so as to lower the extendable and retractable unit 12 in the up and down direction to a height at which the reagent container 2 can be taken in to the certain loading position in the inner circumferential loading board Inner of the reagent storage 3. Then, the control unit of the loading apparatus 1 controls the pick-up part 13 so as to take in the reagent container 2 held by the pick-up part 13 to the certain loading position in the inner circumferential loading board Inner.

Then, at Step S16, the control unit of the loading apparatus 1 controls the motor 115 of the apparatus body 11 so as to raise the extendable and retractable unit 12 in the up and down direction to a height at which the pick-up part 13 can leave the reagent storage 3 via the reagent storage opening 32.

Then, at Step S17, the control unit of the loading apparatus 1 controls the motor 123 of the extendable and retractable unit 12 so as to retract the extendable and retractable unit 12 to its initial length along the horizontal direction, that is, so as to retract the extendable and retractable unit 12 with a stroke of "2".

Finally, at Step S10, the control unit of the loading apparatus 1 controls the motor 115 of the apparatus body 11 so as to lower the extendable and retractable unit 12 to its initial height along the up and down direction.

### Main Effects

As described above, the automatic analysis system 5 according to the second embodiment includes the automatic analysis apparatus, the loading apparatus 1, and the control apparatus 4 (the controller). The automatic analysis apparatus has the reagent storage 3 rotatably provided with the loading board inside and provided with the reagent storage opening 32 on the side. The loading apparatus 1 is an apparatus provided on the side of the reagent storage 3 to take out and take in the reagent container 2 from and to the reagent storage 3 via the reagent storage opening 32. Specifically, as described above, the loading apparatus 1 has the pick-up part 13 (the holding part) for holding the reagent container 2, and the extendable and retractable unit 12 including two- or more-stage arms (the extendable and retractable arms 122) that are extendable and retractable in the direction of the rotational center of the reagent storage 3, with the pick-up part 13 provided at one end of the two- or more-stage arms. The control apparatus 4 extends the extendable and retractable unit 12 in the direction of the rotational center of the reagent storage 3, and controls the pick-up part 13 so as to take out and take in the reagent container 2 from and to the reagent storage 3. Specifically, when the reagent container 2 is taken out and taken in from and to the reagent storage 3, the control apparatus 4 first rotates the loading board such that the certain loading position in the loading board faces the reagent storage opening 32. The control apparatus 4 then extends the extendable and retractable unit 12 in the direction of the rotational center of the reagent storage 3 such that the pick-up part 13 reaches the certain loading position via the reagent storage opening 32. Next, the control apparatus 4 uses the pick-up part 13 to take out and take in the reagent container 2 from and to the certain loading position. The control apparatus 4 then retracts the extendable and retractable unit 12 such that the pick-up part 13 leaves the reagent storage 3.

The present embodiment can achieve the technical effects by the loading apparatus 1 of any of the first embodiment, the first modification, and the second modification.

In the present embodiment, since the reagent storage 3 is provided with the reagent storage openings 32 only on the side, the area of the opening can be made smaller than when a reagent storage opening is provided above or reagent storage openings are provided above and on the side, which can improve the heat retention performance of the reagent storage.

In the automatic analysis system 5 according to the second embodiment, two or more rounds of loading boards are concentrically provided. In this case, when the reagent container 2 is taken out and taken in from and to the outermost circumferential loading board in the reagent storage 3, the control apparatus 4 rotates the outermost circumferential loading board such that the certain loading position in the outermost circumferential loading board faces the reagent storage opening 32. Alternatively, when the reagent container 2 is taken out and taken in from and to a loading board other than the outermost circumferential loading board in the reagent storage 3, the control apparatus 4 rotates another loading board outside the loading board from and to which the reagent container 2 is taken out and taken in such that a vacant position in the other loading board faces the reagent storage opening 32, and rotates the loading board from and to which the reagent container 2 is taken out and taken in such that the certain loading position in the loading board from and to which the reagent container 2 is taken out and taken in faces the reagent storage opening 32.

The present embodiment can accommodate the reagent storage 3 loaded with a plurality of rounds of reagent containers 2.

In the automatic analysis system 5 according to the second embodiment, the loading apparatus 1 has the apparatus body 11, and the extendable and retractable unit 12 is provided relatively movably with respect to the apparatus body 11 in a height direction crossing the extension and retraction direction of the extendable and retractable unit 12. The control apparatus 4, before extending the extendable and retractable unit 12, executes control to raise and lower the extendable and retractable unit 12 along the height direction to a height matching the reagent storage opening 32.

According to the present embodiment, with the above configuration, the pick-up part 13 can release the reagent container 2 after entering the reagent storage 3 and being further lowered with a certain stroke. Thus, since the shaking of the reagent container 2 can be reduced, it is possible to avoid bubbling of the reagent causing misdiagnoses, and it is also possible to avoid splattering of the reagent or toppling over of the reagent bottle (the reagent container 2).

Note that the loading apparatus 1 is provided at the edge of an installation surface in which the reagent storage 3, a reaction unit, and the like of the automatic analysis apparatus are installed. For example, in the examples illustrated in FIGS. 14A, 14B, 15A and 15B, when the installation surface is a rectangle in top view, the areas around the corners (the corners) of the rectangle are dead space. Thus, by installing the loading apparatus 1 in the dead space, the installation surface can be effectively used without waste.

At least one embodiment described above can contribute to improvement in at least the layout of the entire system.

### Others

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

(1) The above embodiments and modifications state that, as an example, the extendable and retractable unit 12 has the three-stage extendable and retractable arms 122 and is configured as a three-stage extendable and retractable structure, but it may be a two-stage extendable and retractable structure or a four- or more-stage extendable and retractable structure so long as it has multi-stage extension and retraction.

(2) In the above embodiments and modifications, in the extendable and retractable unit 12, the motor 123, the pulley 124, and the power transmission belt 125 are used as the parts that provide driving force to the multi-stage extension and retraction, but this is not limiting. For example, a motor and a sprocket and a chain, a motor and a gear and a rack, or the like may be used so long as the driving force can be transmitted between the fixed arm and the extendable and retractable arm on each stage. About the pulley 124 and the power transmission belt 125 in particular, various mechanisms can be substituted so long as they are a mechanism that uses the change in the relative positional relation between the former-stage arm and the latter-stage arm as the driving force for the further-latter-stage arm.

(3) In the above embodiments and modifications, in the extendable and retractable unit 12, the guide rail and the slider are used as the slide guide mechanism that guides the relative slide between the fixed arm 121 and the extendable and retractable arm 122 on each stage, but the present disclosure is not limited to this. For example, a pillar and a bushing, a roller and a slide groove, or the like may be used so long as the slide can be guided.

(4) In the above embodiments and modifications, in the extendable and retractable unit 12, only one motor 123 is provided as the drive part, but a plurality of motors may be provided. For example, by providing one motor for each of the extendable and retractable arms 122, the extendable and retractable arms 122 may be extended and retracted independently.

(5) In the above embodiments and modifications, in the extendable and retractable unit 12, the motor 123 is mounted on the fixed arm 121, but this is not limiting, and it may be mounted on the extendable and retractable arm 122.

(6) In the above embodiments and modifications, in the extendable and retractable unit 12, the fixed arm 121 and the extendable and retractable arms 122 are approximately equal in length, but the present disclosure is not limited to this. For example, the fixed arm 121 and the extendable and retractable arms 122 may be different in length.

(7) In the above embodiments and modifications, in the extendable and retractable unit 12, the first-stage extendable and retractable arm 122 is provided above the fixed arm 121, the nth-stage extendable and retractable arm 122 is provided above the (n-1)th-stage extendable and retractable arm 122, and in the retracted state of the extendable and retractable unit 12, the fixed arm 121 and the extendable and retractable arms 122 are folded and arranged in the up and down direction. However, the present disclosure is not limited to this.

For example, the first-stage extendable and retractable arm 122 may be provided below the fixed arm 121, and the nth-stage extendable and retractable arm 122 may be provided below the (n-1)th-stage extendable and retractable arm 122.

For example, the first-stage extendable and retractable arm 122 may be provided on the side of the fixed arm 121, the nth-stage extendable and retractable arm 122 may be provided on the side of the (n-1)th-stage extendable and retractable arm 122, and in the retracted state, the fixed arm 121 and the extendable and retractable arms 122 may be folded and arranged in the horizontal direction.

Alternatively, a combination of these configurations may be used.

(8) In the above embodiments and modifications, in the apparatus body 11, the motor and the ball screw are used as the drive part that moves and drives the mounting bracket 112 in the up and down direction, but this is not limiting. For example, a motor and a pulley and a transmission belt, a motor and a sprocket and a chain, a motor and a gear and a rack, or an integral linear motor may be used so long as the mounting bracket 112 can be moved and driven in the up and down direction.

(9) In the above embodiments and modifications, in the apparatus body 11, the guide rail and the slider are used as the slide guide mechanism that guides the relative slide between the body bracket 111 and the mounting bracket 112, but the present disclosure is not limited to this. For example, a pillar and a bushing, a roller and a slide groove, or the like may be used so long as the slide can be guided.

(10) In the above embodiments and modifications, the pick-up part 13 is configured to grab and release the reagent container 2 under the control of the control unit, but the present disclosure is not limited to this. For example, the pick-up part 13 may be configured with a vertically upward pointing claw, and an engagement part provided in the reagent container 2 may be hooked and held by operating the motor 115 of the apparatus body 11 to raise the extendable and retractable unit 12, and the hooking between the claw and the engagement part may be released to release the reagent container 2 by operating the motor 115 to lower the extendable and retractable unit 12. In this case, the control unit does not necessarily have to control the pick-up part 13.

(11) In the above embodiments and modifications, the apparatus body 11 is configured to be able to be raised and lowered, but the present disclosure is not limited to this, and it may be configured to be unable to be raised and lowered.

(12) In the above embodiments and modifications, the apparatus body 11 may be configured to be able to turn about an axis along the up and down direction as needed.

(13) In the above modifications, in the support unit 14, the support 143 is L-shaped, but this is not limiting. The support 143 is only required to include the support arm 1431 and the escape arm 1432 coupled to be L-shaped, and its overall shape does not necessarily have to be L-shaped.

(14) In the above modifications, in the support unit 14, the contact part of the support arm 1431 that comes into contact with the extendable and retractable arm 122 to support it is the low-friction part with a lower coefficient of friction with the extendable and retractable arm 122 than other parts. However, the present disclosure is not limited to this, and the coefficient of friction between the contact part and the extendable and retractable arm 122 may be similar to the coefficient of friction between other parts and the extendable and retractable arm 122. In this case, for example, the roller 1433 at the tip of the support arm 1431 may be omitted, and the tip of the support arm 1431 may directly come into contact with the underside of the extendable and retractable arm 122 to support the extendable and retractable arm 122.

(15) In the above modifications, in the support unit 14, the permanent magnets are used as the holding part. However, the present disclosure is not limited to this, and electromagnetic magnets (electromagnets) may be used as the holding part, or other methods such as vacuum suction may be used.

(16) In the above modifications, the support unit 14 is a powerless configuration. However, the present disclosure is not limited to this, and the support unit 14 may have an independent drive part, and the drive part may switch the support unit 14 between the supporting state and the non-supporting state.

(17) The loading apparatus 1 according to the above embodiments and modifications may further be provided with a code reader, and the kind of the reagent may be identified by the code reader. Alternatively, a weight sensor may be provided, and the amount of reagent remaining in the reagent container may be checked by measuring the weight by the weight sensor. Alternatively, a photo sensor may be provided to achieve a function of checking whether the reagent container is present at a target position.

(18) In the above second embodiment, the loading apparatus and the automatic analysis apparatus have the control unit. However, this is not limiting. The loading apparatus and the automatic analysis apparatus do not necessarily have to have the control unit, and the control apparatus 4 of the automatic analysis system 5 may control each part in the automatic analysis system 5. In that case, the control apparatus of the automatic analysis system 5 constitutes the controller.

(19) In the above second embodiment, the automatic analysis system 5 has the control apparatus, each control unit of the loading apparatus and automatic analysis apparatus achieves control of the loading apparatus and the automatic analysis apparatus under the control of the control apparatus 4 of the automatic analysis system 5, and the control apparatus 4, the control unit of the loading apparatus, and the control unit of the automatic analysis apparatus constitute the controller that controls each part in the automatic analysis system 5. However, the present disclosure is not limited to this. The automatic analysis system 5 does not necessarily have to have the control apparatus 4. In that case, the control unit of the loading apparatus and the control unit of the automatic analysis apparatus constitute the controller.

What is claimed is:

1. A loading apparatus for taking out and taking in a reagent container from and to a rotatable reagent storage of an automatic analysis apparatus, the loading apparatus comprising:
a holding part configured to hold the reagent container; and
an extendable and retractable unit including two- or more-stage arms that are extendable and retractable in a direction of a rotational center of the reagent storage, and being provided with the holding part at one end of the two- or more-stage arms,
the extendable and retractable unit extending in the direction of the rotational center of the reagent storage to take out and take in the reagent container from and to the reagent storage using the holding part.

2. The loading apparatus according to claim 1, wherein
two or more rounds of loading boards that load the reagent container are provided inside the reagent storage, and
the extendable and retractable unit extends to any loading board out of the two or more rounds of loading boards inside the reagent storage in the direction of the rotational center of the reagent storage to take out and take in the reagent container from and to the any loading board using the holding part.

3. The loading apparatus according to claim 1, wherein the two- or more-stage arms extend and retract in conjunction with each other.

4. The loading apparatus according to claim 1, wherein in a retracted state of the extendable and retractable unit, the two- or more-stage arms are folded and arranged.

5. The loading apparatus according to claim 4, wherein in the retracted state of the extendable and retractable unit, the two- or more-stage arms are folded and arranged in a height direction crossing an extension and retraction direction of the extendable and retractable unit.

6. The loading apparatus according to claim 4, wherein
the two- or more-stage arms are equal in length in an extension and retraction direction of the extendable and retractable unit, and
in the retracted state of the extendable and retractable unit, respective both ends of the two- or more-stage arms in the extension and retraction direction are aligned with each other.

7. The loading apparatus according to claim 1, wherein
the loading apparatus has an apparatus body, and
the extendable and retractable unit is provided relatively movably with respect to the apparatus body in a height direction crossing an extension and retraction direction of the extendable and retractable unit.

8. The loading apparatus according to claim 1, wherein the loading apparatus has a support unit that is switched to a supporting state, which supports the arms, or a non-supporting state, which does not support the arms, in conjunction with extension and retraction of the extendable and retractable unit.

9. The loading apparatus according to claim 8, wherein the support unit supports only an arm provided with the holding part out of the two- or more-stage arms.

10. The loading apparatus according to claim 8, wherein
the support unit is rotatably provided below an extension and retraction path of the arms, and has a support having a support arm that becomes a fallen attitude in the non-supporting state and becomes an erect attitude in the supporting state, and an escape arm coupled to the support arm in an L shape, and
the support
in a process in which the extendable and retractable unit extends, rotates by the escape arm being pushed by the holding part or the reagent container held by the holding part, by which the support arm becomes the erect attitude to support the arms, and
in a process in which the extendable and retractable unit retracts, rotates by the support arm being pushed by the holding part or the reagent container held by the holding part, by which the support arm becomes the fallen attitude.

11. The loading apparatus according to claim 10, wherein a contact part of the support arm that comes into contact with the arms to support the arms is a low-friction part with a lower coefficient of friction with the arms than other parts.

12. The loading apparatus according to claim 11, wherein the contact part is a roller rotatably provided in the support arm.

13. The loading apparatus according to claim 10, wherein
the support unit has an attitude holding part that holds the fallen attitude or the erect attitude that is currently presented of the support arm of the support with a certain magnitude of force, and
the holding part or the reagent container held by the holding part exerts a pressing force of a magnitude capable of countering the force on the support arm or the escape arm in extension and retraction of the extendable and retractable unit.

14. The loading apparatus according to claim 13, wherein
the attitude holding part is a magnet, and
the support arm and the escape arm are made of a magnetic metal material.

15. The loading apparatus according to claim 8, wherein
the loading apparatus has an apparatus body,
the extendable and retractable unit is provided relatively movably with respect to the apparatus body in a height direction crossing an extension and retraction direction of the extendable and retractable unit,
a downward recess is formed in the arm supported by the support unit, and
when the extendable and retractable unit extends to a state in which the reagent container is capable of being taken out and taken in from and to the reagent storage, the downward recess is positioned above a part of the support unit that supports the arm.

16. An automatic analysis system comprising:
an automatic analysis apparatus rotatably provided with a loading board inside, and having a reagent storage provided with a reagent storage opening on a side;
a loading apparatus provided on a side of the reagent storage, and configured to take out and take in a reagent container from and to the reagent storage via the reagent storage opening; and
a controller,
the loading apparatus having:
a holding part for holding the reagent container; and
an extendable and retractable unit including two- or more-stage arms that are extendable and retractable in a direction of a rotational center of the reagent storage, and being provided with the holding part at one end of the two- or more-stage arms, and
the controller controlling the holding part so as to extend the extendable and retractable unit in the direction of the rotational center of the reagent storage and to take out and take in the reagent container from and to the reagent storage.

17. The automatic analysis system according to claim 16, wherein
the controller executes, when the reagent container is taken out and taken in from and to the reagent storage,
a first process to rotate the loading board such that a certain loading position in the loading board faces the reagent storage opening,
a second process to extend the extendable and retractable unit in the direction of the rotational center of the reagent storage such that the holding part reaches the certain loading position via the reagent storage opening,
a third process to take out and take in the reagent container from and to the certain loading position using the holding part, and
a fourth process to retract the extendable and retractable unit such that the holding part leaves the reagent storage.

18. The automatic analysis system according to claim 17, wherein
two or more rounds of the loading boards are concentrically provided, and
when the reagent container is taken out and taken in from and to an outermost circumferential loading board in the reagent storage, the controller, in a first process, rotates the outermost circumferential loading board such that the certain loading position in the outermost circumferential loading board faces the reagent storage opening.

19. The automatic analysis system according to claim 18, wherein when the reagent container is taken out and taken in from and to a loading board other than the outermost circumferential loading board in the reagent storage, the controller, in the first process, rotates another loading board outside the loading board from and to which the reagent container is taken out and taken in such that a vacant position in the other loading board faces the reagent storage opening, and rotates the loading board from and to which the reagent container is taken out and taken in such that the certain loading position in the loading board from and to which the reagent container is taken out and taken in faces the reagent storage opening.

20. The automatic analysis system according to claim 17, wherein
the loading apparatus has an apparatus body,
the extendable and retractable unit is provided relatively movably with respect to the apparatus body in a height direction crossing an extension and retraction direction of the extendable and retractable unit, and
the controller, before the second process, executes control to raise and lower the extendable and retractable unit along the height direction to a height matching the reagent storage opening.
